(19) United States
(12) Patent Application Publication
(10) Pub. No.: US 2002/0143621 A1
(43) Pub. Date: Oct. 3, 2002

(54) System and method for transferring credits as an incentive for prompt payment

(76) Inventors: Dennis P. Donnelly, Des Moines, IA (US); John E. Donnelly, Des Moines, IA (US); Thomas J. Donnelly, Des Moines, IA (US); Joel D. Van Zomeren, Burnsville, MN (US)

Correspondence Address: DORSEY & WHITNEY LLP, ATTORNEYS AT LAW, 801 GRAND, SUITE 3900, DES MOINES, IA, 50309, US

(21) Appl. No.: 09/822,544

(22) Filed: Mar. 30, 2001

(51) Int. Cl. G06F 17/60

(52) U.S. Cl. 705/14

(57) ABSTRACT

The present invention provides a system and process for creating incentives for a customer to timely pay billed charges identified on a Sponsor's books as an accounts receivable by offering a credit redeemable with a third party vendor via an Internet or other telecommunications link based system. The present invention generates credits, which are preferably travel vouchers, based upon an identification of qualified accounts receivables by at least one Sponsor. The process includes the steps of identifying a Recipient, identifying the qualified accounts receivables associated with the Recipient, and generating a travel voucher redeemable with a travel agency based upon the value of the qualified accounts receivables. The system of the present invention is preferably implemented using an Application Service Provider (ASP) accessible via an Internet or other network connection.

### FIELD OF THE INVENTION

The present invention relates to the field of award systems which provide incentives for clients or customers to promptly pay billed charges. More specifically, the present invention relates to the field of providing travel credits to clients/customers who promptly pay charges billed for the purchase of goods or services provided at the time of receipt/purchase on an accounts receivables basis.

### BACKGROUND OF THE INVENTION

Doctors, dentists, lawyers, other service providers, and merchants (hereafter, “Sponsors”) often provide goods/services to customers/clients on an accounts receivable basis such that the customer does not pay in full at the time of purchase (or when the services are rendered) and instead is billed at a later time. As is common in many industries and/or service sectors, the collection of payment for billed charges (which are commonly recorded on a Sponsor's books as an accounts receivable) is often delayed or late due to numerous factors. To decrease the service-billing-collection cycle time line (i.e., the amount of time required from the initiation of the service or providing of the goods through the billing and receipt of payment from the customer), Sponsors have utilized various incentive programs to encourage customers to pay promptly, regularly, and timely.

One incentive system well known in the art provides a discount for early payment. Agreements providing discounts for early payment of accounts receivables are often expressed in terms of 10 net 30 (wherein the client gets a 10% discount if they pay the bill in full within 30 days from the date the bill was mailed) and similar terms. As is commonly known in the industry, discount incentives are often unpopular because they reduce the fees received by the Sponsor on a per-invoice basis and may result in significantly large discounts being offered (for example, on a large purchase order) or trivially small discounts being offered (for example, on a doctor's office visit costing under $100). For the significantly large discounts, the Sponsor often provides too large of an incentive (i.e., the customer would have probably been motivated to pay early with a smaller discount). For the trivially small discounts, the discount is not an effective motivational tool because the savings realized by the customer are often trivial. Additionally, percentage discounts are undesirable because they generally are not cumulative. Thus, a repeat customer who is eligible for a small discount is not motivated to collect numerous occasions of the small discounts in order to eventually receive a larger reward. Further, percentage discount programs require the Sponsor to track when payments are received (i.e., was the payment received in the time frame specified and thus eligible for a discount), actually record the appropriate discounts and offer reimbursement in certain circumstances, and often require additional accounting tasks to be performed and accounting systems to be utilized. Therefore, for many Sponsors, percentage discount incentive programs are undesirable and/or impractical.

Another incentive program currently utilized provides for the awarding of travel vouchers to customers for prompt payment. In such a program, a travel discount voucher administrator (hereinafter, an “Administrator”) sells travel stamps to a Sponsor. In lieu of cash discounts, the stamps are provided by the Sponsor to those customers with prompt payment histories. The customers then redeem the stamps with travel agents that accept the stamps in lieu of, or in addition to, payment via cash, check, or credit card.

However, such an incentive program has several inherent disadvantages. First, the program is very labor intensive for the Sponsor. Since the stamps have some value associated with them and are not traceable, the stamps are generally treated similar to cash (i.e., they must be safeguarded and accounted for on a daily basis). Second, the incentive for customers to pay early provided by the stamps is often ineffective because the stamps are equally labor intensive upon the customers. Since a single stamp is often insufficient to make much of a difference in the cost of travel, a large quantity of stamps must be awarded, collected, and saved in order for a substantial saving to be realized by the customer. Most customers do not have the time or effort to save such stamps and thus the program is often ineffective. Further, since the stamps are not traceable, providers do not know which clients actually use the stamps or whether the stamps program is creating the incentives desired (i.e., motivating a client to pay early).

Additionally, the redemption of the stamps may be problematic for many customers. In order to redeem a stamp, the stamps must pass from the program administrator (a third party) to a Sponsor, to a customer, to a travel agent and then back to the program administrator who then pays the travel agent for the value of the redeemed stamps. As can be readily appreciated, travel agents often are reluctant to receive stamps instead of payment in kind, since the stamps must then be redeemed with the program administrator before payment is received. Travel agents would rather receive immediate payment in the form of cash, check, or credit card than receive a bunch of stamps which require separate redemption steps.

Therefore, a system and process is needed with allows Sponsors to offer incentives to customers to quickly pay-off outstanding account receivables balances. Preferably, such a system and process is not labor intensive, provides tracking and other reporting capabilities, and provides immediate and direct compensation to businesses without requiring the customer or the third party vendor to accept stamps or similar items.

### SUMMARY OF THE INVENTION

The present invention provides a process and system for encouraging customers to pay billed charges timely by providing incentives to such customers or their designated recipients (hereafter, customers and their designated recipients are collectively referred to as “Recipient”) in the form of credits. The process of awarding such credits begins when a Sponsor identifies to an Administrator, of an incentive awards program, a Recipient and the amount of qualified accounts receivables the Recipient has paid on a timely basis.

This information is then utilized by the Administrator to generate credits which are saved in an account associated with a designated Recipient (the recipient may or may not be the customer who timely paid the billed charges), while a notification of the awarding of such credits is also provided to the Sponsor. At the time desired by the Recipient, such credits may then be designated for redemption to a third party vendor to offset the costs of goods/services the Recipient intends to purchase.

At this point, the Administrator approves or disapproves the request. If the request is approved, the Administrator communicates payment information to the third party vendor-thereby reducing the cost of the goods/services to be acquired by the Recipient by the dollar value amount of the credits to be redeemed by the Recipient. The Recipient then utilizes their own funds to pay-off the remaining costs of the acquired goods/services. In some instances, the Administrator will allow the Sponsor to hold the Recipient's travel credits. In this case, the Sponsor pays the associated fees on a monthly basis to the Administrator as the Administrator invoices the Sponsor for redeemed travel credits at the time of redemption.

A system for implementing such a process is preferably accomplished via the Internet. Communications between the Sponsor and the Administrator and the Administrator and the Recipient are preferably facilitated via electronic means including, for example, email, file transfers, data downloads, web pages and other forms of electronic commerce. The present invention may also utilize more traditional means of communications, when desired, such as, telephones, regular mail, facsimiles, and pages. The system preferably includes a Sponsor system which is implemented on a personal computer or business computing systems. It also includes an Administrator system which is configured as an Application Service Provider (ASP). Further, a Recipient system is preferably implemented on a personal computer, while the third party vendor system may be any system and may or may not be connected to the Administrator, the Sponsor, or the Recipient via the Internet.

Further, in the preferred embodiment, the credits awarded are to be utilized to purchase travel related goods and services, such as airfare and hotel accommodations. Such credits are preferably awarded for timely payment by a Recipient of billed charges (which generally appear on a Sponsor's books as an accounts receivables). However, the present invention may be utilized to award credits for any goods/services based upon any factor or variable and is not limited to awarding travel credits based upon an accounts receivables payment history.

### BRIEF DESCRIPTION OF THE DRAWING FIGURES

FIG. 1 is a flow diagram illustrating the process by which credits are provided to a Recipient based upon the Recipient's payment history for a preferred embodiment of the present invention.

FIG. 2 illustrates a system for providing credits to a Recipient based upon the Recipient's payment history for a preferred embodiment of the present invention.

FIG. 3 is a flow diagram which illustrates the process by which a Sponsor awards a credit to a Recipient and how the Administrator interfaces with a Sponsor for a preferred embodiment of the present invention.

FIG. 4 is a flow diagram which illustrates the process by which a Recipient designates awarded credits for redemption and by which the Recipient interfaces with an Administrator for a preferred embodiment of the present invention.

FIG. 5 is a flow diagram which illustrates the process by which an Administrator of a credit awarding system manages the awarding, redemption, and transactional components thereof for a preferred embodiment of the present invention.

FIGS. 6A and 6B are screen shots of a Home page for an Internet based travel credit awarding embodiment of the present invention.

FIG. 6C is a screen shot of additional information provided in conjunction with the Home page of FIGS. 6A and 6B for an Internet based travel credit awarding embodiment of the present invention.

FIGS. 7A and 7B are screen shots of the Sponsor Sign-Up page for an Internet based travel credit awarding embodiment of the present invention.

FIG. 7C is an illustration of a representative email message sent to a new Sponsor for an Internet based travel credit awarding embodiment of the present invention.

FIG. 8 is a screen shot of the Welcome Sponsor page for an Internet based travel credit awarding embodiment of the present invention.

FIG. 9 is screen shot of the Welcome Back Sponsor page for an Internet based travel credit awarding embodiment of the present invention.

FIG. 10 is a screen shot of the My Customer List page for an Internet based travel credit awarding embodiment of the present invention.

FIGS. 11A and 11B are screen shots of a data entry field and a populated data entry field, respectively, in which a Sponsor identifies a Recipient for an Internet based travel credit awarding embodiment of the present invention.

FIG. 12 is a screen shot of the Customer Added page indicating that a customer has been added to a database associated with a Sponsor for an Internet based travel credit awarding embodiment of the present invention.

FIG. 13 is a screen shot of the My Prospect List page for an Internet based travel credit awarding embodiment of the present invention.

FIG. 14 is a screen shot of a data entry field in which a Sponsor identifies a prospect for an Internet based travel credit awarding embodiment of the present invention.

FIG. 15 is a screen shot of a page in which a new a Sponsor is notified of a new prospect's pin number and password for an Internet based travel credit awarding embodiment of the present invention.

FIG. 16 is a screen shot of the My Qualifying Receivables page for an Internet based travel credit awarding embodiment of the present invention.

FIG. 17 is a screen shot of a report of qualifying receivables posted by a Sponsor for an Internet based travel credit awarding embodiment of the present invention.

FIG. 18 is a screen shot of the Transaction Entry page for an Internet based travel credit awarding embodiment of the present invention.

FIG. 19 is a screen shot of a page utilized to input transaction information for an Internet based travel credit awarding embodiment of the present invention.

FIGS. 20A and 20B are screen shots of the populated fields for a transaction which have been designated by a Sponsor to be saved and finalized for an Internet based travel credit awarding embodiment of the present invention.

FIG. 21 is a screen shot of a message communicated to a Sponsor indicating that a transaction has been successfully inputted and saved for an Internet based travel credit awarding embodiment of the present invention.

FIG. 22 is a screen shot of the Welcome Recipient page for an Internet based travel credit awarding embodiment of the present invention.

FIG. 23 is a screen shot of the Recipient Options page for an Internet based travel credit awarding embodiment of the present invention.

FIG. 24 is a screen shot of the My Preferences page utilized by a Recipient to specify their preferences for an Internet based travel credit awarding embodiment of the present invention.

FIG. 25A is a screen shot of a page via which a Recipient specifies which travel credits to review for an Internet based travel credit awarding embodiment of the present invention.

FIG. 25B is a screen shot of a page displaying all the travel credits available for a Recipient for an Internet based travel credit awarding embodiment of the present invention.

FIG. 25C is a screen shot of a page displaying pending travel requests for a Recipient for an Internet based travel credit awarding embodiment of the present invention.

FIG. 25D is a screen shot of a page displaying approved travel requests for a Recipient for an Internet based travel credit awarding embodiment of the present invention.

FIG. 25E is a screen shot of a page displaying credits awarded by Sponsor for a Recipient to review for an Internet based travel credit awarding embodiment of the present invention.

FIG. 26 is a screen shot of the Request Travel Voucher page for an Internet based travel credit awarding embodiment of the present invention.

FIG. 27 is a screen shot of a message communicated to a Recipient by an Administrator upon submission of a travel voucher request for an Internet based travel credit awarding embodiment of the present invention.

FIG. 28 is a screen shot of an email message communicated from an ASP to an Administrator seeking approval of a travel voucher request for an Internet based travel credit awarding embodiment of the present invention.

FIG. 29 is a screen shot of Administrator Options page for an Internet based travel credit awarding embodiment of the present invention.

FIG. 30 is a screen shot of the Sponsor Setup page for an Internet based travel credit awarding embodiment of the present invention.

FIG. 31A is a screen shot of the Sponsor Maintenance page for an Internet based travel credit awarding embodiment of the present invention.

FIG. 31B is a screen shot of the Sponsor Setup Data Entry page for an Internet based travel credit awarding embodiment of the present invention.

FIG. 31 C is a screen shot of a message communicated to an Administrator by the ASP after a new Sponsor has been set-up and a pin number assigned thereto for an Internet based travel credit awarding embodiment of the present invention.

FIG. 32A is a screen shot of the Recipient Setup page for an Internet based travel credit awarding embodiment of the present invention.

FIG. 32B is a screen shot of the Recipient Maintenance page for an Internet based travel credit awarding embodiment of the present invention.

FIG. 32C is a screen shot of the Recipient Setup Data Entry page for an Internet based travel credit awarding embodiment of the present invention.

FIG. 32D is a screen shot of a message communicated to an Administrator by the ASP after a new Recipient has been set-up and a pin number assigned thereto for an Internet based travel credit awarding embodiment of the present invention.

FIG. 33A is a screen shot of the Travel Voucher Approval page for an Internet based travel credit awarding embodiment of the present invention.

FIG. 33B is a screen shot of a voucher needing approval as presented to an Administrator for an Internet based travel credit awarding embodiment of the present invention.

FIG. 33C is a screen shot of a message generated by the ASP to the Administrator indicating that a voucher has been approved for an Internet based travel credit awarding embodiment of the present invention.

FIG. 33D is a screen shot of a Sponsor Approval page for an Internet based travel credit awarding embodiment of the present invention.

FIG. 33E is a screen shot of a Transaction Approval page for an Internet based travel credit awarding embodiment of the present invention.

FIG. 33F is a screen shot of a transaction needing approval by an Administrator for an Internet based travel credit awarding embodiment of the present invention.

FIG. 33G is a screen shot of a message generated by the ASP to the Administrator indicating that a transaction has been approved for an Internet based travel credit awarding embodiment of the present invention.

FIG. 34 is a screen shot of a page providing download options to an Administrator for an Internet based travel credit awarding embodiment of the present invention.

FIG. 35 is a screen shot of a Sponsor Download Layout page for an Internet based travel credit awarding embodiment of the present invention.

FIG. 36 is a screen shot of a Recipient Download Layout page for an Internet based travel credit awarding embodiment of the present invention.

FIG. 37 is a screen shot of a Transaction Download Layout page for an Internet based travel credit awarding embodiment of the present invention.

FIG. 38 is a screen shot of a Prospect Download Layout page for an Internet based travel credit awarding embodiment of the present invention.

FIG. 39 is a screen shot of a page providing reporting options to an Administrator for an Internet based travel credit awarding embodiment of the present invention.

FIG. 40 is a screen shot of an Auto Email Statements control page for an Internet based travel credit awarding embodiment of the present invention.

FIG. 41 is an illustration of an email message notifying a Sponsor that a transaction has been posted for an Internet based travel credit awarding embodiment of the present invention.

FIG. 42 is a screen shot of a message generated by the ASP to the Administrator notifying that messages have been sent for an Internet based travel credit awarding embodiment of the present invention.

FIG. 43 is a screen shot of the Auto Email Voucher Notices page for an Internet based travel credit awarding embodiment of the present invention.

FIG. 44 is an illustration of an email message notifying a Recipient that their travel voucher request has been approved for an Internet based travel credit awarding embodiment of the present invention.

FIG. 45 is an illustration of an email message notifying a Sponsor that a Recipient has redeemed travel credits for an Internet based travel credit awarding embodiment of the present invention.

### DETAILED DESCRIPTION OF A PREFERRED EMBODIMENT

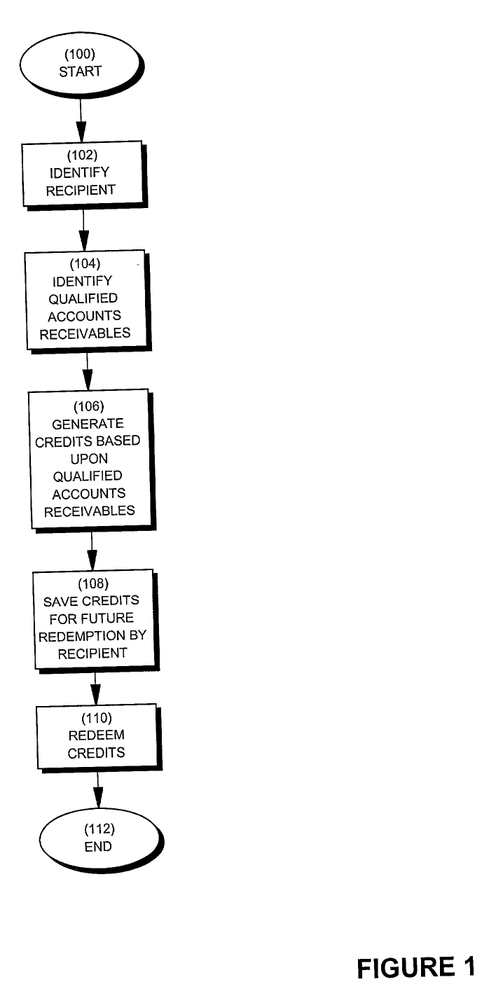

As shown in FIG. 1, a preferred embodiment of the present invention provides a process for awarding credits to customers of a Sponsor as an incentive for paying off accounts receivables or other charges in a timely manner. As shown, the process preferably begins when a Sponsor identifies a recipient, who has qualified for the incentive program, to an Administrator which rewards, stores and redeems credits offered by the Sponsor to the Recipient (Step 102). It is to be appreciated that the process is preferably compatible with any system utilized by a Sponsor for awarding credits and is not limited to a process or system which awards credits only for the prompt payment of accounts receivables. Further, the process and system of the present invention may be utilized to identify any person or entity as the recipient and need not necessarily identify the customer as the recipient of the credits. For example, a Sponsor who is an optician might desire to provide a program wherein credits are issued in the name of every Recipient paying early to a charitable organization providing glasses to third world countries. Therefore, it is to be appreciated that the process may be custom configured by Sponsors and/or administrators to provide credits to any Recipient (for example, a person, an entity, a charitable organization, etc.) based upon any criteria.

Once the Recipient has been identified, the process continues with the Sponsor identifying qualified accounts receivables upon which the credit award is based (Step 104). As mentioned previously, the process of the preferred embodiment is described herein as a process for awarding credits based upon the timely payment of account receivables (i.e., accrued charges billed to a Recipient). However, it is to be appreciated that the process may be utilized to award credits based upon other performances by a Recipient (for example, earning straight “A's” in school might result in the awarding of $20 credits at a local record store) and is not to be construed as being limited to only awarding credits for prompt payments of billed charges. In the preferred embodiment, the Sponsor preferably identifies qualified accounts receivables by inputting such information into an Internet based credit awarding service. In other embodiments, the qualified accounts receivables are provided automatically to the Administrator through an automated file transfer protocol which identifies those accounts paid in full for a given time period. The use of automated accounting systems which identify good accounts (i.e., accounts paid in full) and delinquent accounts are well known in the art and are not discussed further herein. The process may suitably utilize such automated accounting systems as desired.

Further, for alternative embodiments, in which the awarding of credits is based upon factors other than accounts receivables and payment histories, the process is suitably modified such that manual or automated notifications of qualified accounts, records, etc. may be received and processed. As such, the process suitably allows a Sponsor to identify a Recipient and the qualified activities (for example, accounts receivables timely paid by the Recipient) upon which an awarding of a credit to the Recipient is based.

Upon receiving a notification of both the Recipient and the qualified accounts receivables, the process preferably generates and awards credits to the Recipient based upon the qualified accounts receivables (Step 106). In the preferred embodiment, the credits are generated on a monthly basis based upon the payment status of the Recipient for the previous billing period (i.e., whether a timely payment for the previous period was received) and the amount of billed charges (i.e., accounts receivables). Thus, for Recipients who repetitively are billed and pay approximately the same amount each month, the credit is often the same each month. In contrast, for single use Recipients, or Recipients whose purchases of goods/services very substantially each month, the credits awarded for a given period may vary significantly from a previous period. While the preferred embodiment is configured such that the credit is based solely upon the current amount of accounts receivables timely paid off, it is to be appreciated that the process may be configured to consider past payment history (for example, by rewarding a larger credit for Recipients who have paid on time for three months in a row) or other variables. Thus, the process may be configured to award credit's based upon any variable desired by the Sponsor and/or the Administrator and is not limited to a single process or system.

Once the credits are generated, the process continues with the Administrator saving the credits, which are preferably in an electronic format, in an account associated with the Recipient (Step 108). At this point of the process, the Recipient is preferably vested with the credits awarded. In the preferred embodiment, the credits are redeemable for travel based charges (i.e., airline tickets, rental cars, hotel reservations, etc.). However, the credits may be designated as being redeemable for items other than travel, for example, a credit at a participating store. The process preferably, however, vests the Recipient with the credits at the time of generation/awarding and does not require the Sponsor or the Administrator to mail the credits to the Recipient, notify the Recipient of the credits, or perform other time intensive acts. Thus, the process frees the Sponsor from having to administer the distribution of credits to Recipients; such functions are accomplished automatically by the Administrator. Further, since the credits are awarded electronically into an account associated with the Recipient, Sponsors and Administrators do not have to “guard” or secure the credits. Instead, the Administrator merely needs to secure the database maintaining the credit and account records. Those skilled in the art appreciate the system and safeguards needed to provide a desired level of security and data integrity. The present invention may utilize any suitable system and process for securing and maintaining the credits.

Once the credits have been generated and saved in the Recipient's account, the process continues with the Administrator preferably notifying the Recipient and the Sponsor of the awarding of the credits. This notification hopefully provides the Sponsor with another opportunity to market their goods/services while also garnering goodwill between the Sponsor and the Recipient(s). Such notification may be accomplished by any systems known in the art including email, page, regular mail, telephone call, posting on an Internet page, etc. In the preferred embodiment, the award notification is preferably accomplished via an email message.

The process then continues with the Recipient redeeming the credits (Step 110). The Recipient is not required to utilize the credits immediately upon receipt thereof and instead may elect to save and store up the credits until a desired amount of credits have been awarded. As such, the Recipient may save credits until, for example, a free flight may be obtained, or a significant reduction in the price of a good/service may be obtained. Importantly, in the preferred embodiment, the credits are associated with a given dollar value. Thus, when redeemed, the credits preferably function much like store coupons, in that they reduce the price of a good/service by a specific, pre-determined amount. Those skilled in the art appreciate that while the preferred embodiment awards credits in terms of monetary values, other methods of valuation may also be utilized without departing from the spirit or scope of the present invention.

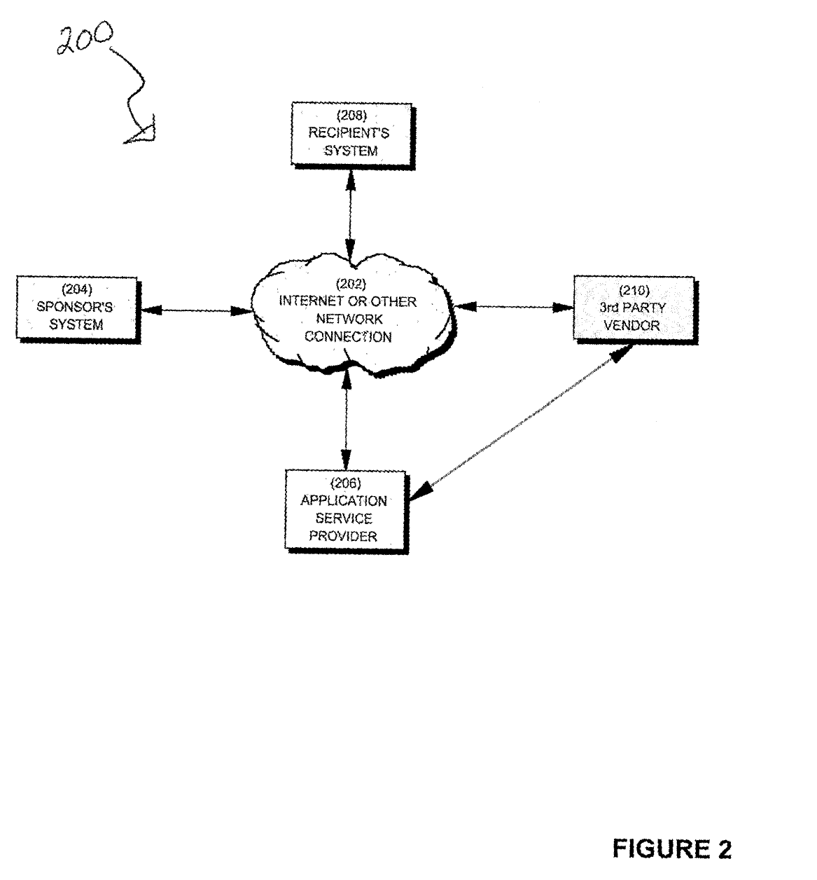

Referring now to FIG. 2, the preferred embodiment of a system 200 implementing the present invention provides communications between the Sponsor's system 204, the Recipient's system 208, the Administrator's Application Service Provider system (ASP) 206, and a third party vendor's system 210 via an Internet or a similar network connection 202. As shown, the system 200 preferably includes a Sponsor's system 204 which provides those data processing capabilities necessary to identify Recipients who qualify for a credit award.

As mentioned previously, Recipients preferably qualify for credit awards by timely paying their bills to the Sponsor (i.e., the accounts receivable associated with a customer and maintained on a Sponsor's ledger are timely paid by the customer). The system is neutral as to how bills are communicated to Recipients and how payments thereon are received and processed by Sponsors. As such, the Sponsor's system 204 may incorporate any degree of accounting and payment system automation desired. For example, one Sponsor using the system 200 may desire to communicate bills to and receive payments from Recipients using the regular mail. In contrast, another Sponsor may desire to communicate bills via the Internet and receive payments via electronic fund transfers, credit card numbers, or in a similar automated fashion. Thus, the system is compatible with any level of accounting automation desired by a Sponsor and/or a Recipient.

The Sponsor's system 206 is preferably implemented on a computer workstation utilizing, for example, a Pentium® processor and providing Internet capabilities and accounting capabilities. In the preferred embodiment, the Sponsor's system 206 is utilized by an accounting department to perform accounting and bookkeeping functions. However, other devices may also be utilized as a Sponsor's system 204, as desired, depending upon various factors, for example, the level of automation and data processing utilized by a Sponsor. For example, a Sponsor with a low volume may not want to integrate their bookkeeping software and systems with the system 200 of the preferred embodiment. Instead, such information may be communicated to the ASP 206 via manual or semi-automatic processes, for example, using pull down lists and data entry tables. Thus, the present invention is not limited to any specific systems or capabilities and may be utilized in conjunction with any devices/systems which support the features and functions identified herein and as expressed in the claims.

The system 200 is also technology neutral with regards to how Sponsors notify an Administrator about eligible Recipients and their qualified accounts receivables. In the preferred embodiment, such notifications/communications are accomplished by logging onto the Administrator's ASP 206 via the Internet. When logged on, as will be discussed later herein, the Sponsor suitably identify's the eligible Recipients and the qualified accounts receivables (which, as discussed previously, are associated with the Recipient who may or may not be the actual Recipient of the credit award). Such identification may be made, for example, by inputting such information into the appropriate data fields or by selecting a Recipient from a pull-down menu. Additionally, the transfer of accounts receivables information is also preferably automated such that the Sponsor needs to only select the data (or have the automated software select the data) desired to be communicated to the ASP 206. The selection and transmission of such data between systems is well known in the art and is not discussed further herein. Thus, the system may utilize any systems and/or processes for communicating an identification of Recipients and eligible accounts receivables (or other factors) from the Sponsor to the ASP 206.

Additionally, the system 200 may be configured such that specific items of information may be used as the basis for credits being generated. In the preferred embodiment, the Sponsor's system 204 and the ASP 206 are both configured such that specific activities by a Recipient generate specific credits. For example, the system 200 may be configured such that an optical lab rewards credits (or additional credits) when a Recipient purchases a premium product, regardless of whether the Recipient pays their bill on time. Similarly, the system may also be configured such that credits are withdrawn from a Recipient's account for non-timely payment of billed and undisputed charges. Thus, the system 200 may be configured to provide and redeem credits based upon any activity, but in the preferred embodiment such activity is the timely payment of accounts receivables.

As mentioned previously, the system 200 also includes the ASP 206. The ASP 206 provides the centralized data processing features necessary to implement the present invention. More specifically, the ASP 206 provides those databases, transaction processing capabilities (for example, credit card processing and electronic fund transfers), performance tracking (monitoring which Recipients actually redeem credits), and other functions specified herein or otherwise known in the art to support the present invention. The ASP 206 is platform independent and may be provided using a computer workstation, a centralized server, a main frame processor or other computing system configurations. Additionally, the ASP 206 may be, in actuality, a plurality of servers which utilize distributed processing to accomplish the features and functions of the present invention. For example, as is well known in the art, one processor of a distributed system may be responsible for controlling data flow in and out of databases while a second processor (which may or may not be co-located with the first processor) may be responsible for controlling the transfer of funds between the Administrator, the Sponsor, the Recipient and/or the 3^{rd} party vendor 210 (for example, a travel agency).

In addition to the features and functions already mentioned, the ASP 206 also provides an Administrator of a program for awarding credits the capabilities of providing the tax forms required by the IRS when a credit is awarded based upon something other than a product or service discount. For example, credits awarded based upon performance at work (i.e., a bonus) might require an IRS Form 1099. The ASP 206 preferably provides those systems necessary to prepare and distribute such forms to the needed parties.

The ASP 206 also is preferably capable of being configured such that credits and interfaces with a Recipient and a 3^{rd} party vendor all appear to be coming directly from the Sponsor and not through an Administrator. In this embodiment, instead of Travelflo® credits being awarded, Company X credits are awarded (where Company X is the Sponsor). Similarly, the web sites and interfaces may be configured to reflect the Company X name instead of the Travelflo name. This “private label credit” feature further enhances the goodwill garnered between the Sponsor, the Recipient and the 3^{rd} party vendor. Similarly, the ASP 206 preferably provides the capability of generating broadcast advertisements on email messages communicated to Recipients. In this manner, the Sponsor may notify each Recipient of specials being provided when the Recipient is highly receptive to such marketing efforts (i.e., after receiving a credit, the Recipient is probably receptive to the concept of engaging in further business with the Sponsor).

The ASP 206 may also be configured as a provider of travel related services, goods, and other items. As is well known in the art, travel services may be provided via the Internet. The present invention enables an Administrator of a credit redemption system to provide vendor services directly, instead of such services being provided independently by a 3^{rd} party vendor 210. In such an embodiment, the ASP 206 facilitates the reservation of travel and utilizes the credits directly to reduce the costs of travel instead of providing such credits to the 3^{rd} party vendor 210. Similarly, the ASP 206 may be configured to market and sell goods via the Internet, while using the credits to reduce the costs of such goods. The providing of online travel services and/or online merchandising is well known in the art. The present invention may be utilized in conjunction with any suitable systems, as desired, and is not to be construed as being limited to any specific systems or processes.

Referring again to FIG. 2, the system of the preferred embodiment also includes a Recipient's system 208. The Recipient's system 208 provides those features and functions necessary to enable a Recipient (who may or may not be a customer) to receive notifications of credits awarded, monitor such credits, and redeem the credits as and when desired. In the preferred embodiment, the credits may be redeemed by the Recipient at any time and at any place. The process by which credits are redeemed with a 3^{rd} party vendor 210 for the preferred embodiment are discussed further in greater detail herein. The Recipient's system 208 may be provided on any device capable of connecting with the ASP 206. In the preferred embodiment the Recipient's system 208 is Internet compatible, however, other networks and systems for communicating information may be utilized including, but not limited to, private networks, public networks, telecommunications networks (both wired and wireless), and other networks or connectivity systems. Further, in the preferred embodiment, a personal computer is utilized as the Recipient's system 208, however, those skilled in the art appreciate that other systems may be utilized, such as, telephones, personal data assistants, pagers, and similar devices. Thus, the system 200 may be configured, as desired, to be compatible with any level of communication technologies. In the preferred embodiment, email and Internet based web pages are preferably utilized.

The final component of the system 200 is the 3^{rd} party vendor 210. The 3^{rd} party vendor 210 may be any group, person, or entity who provides goods/services to the Recipient. When a Recipient seeks to redeem credits in order to purchase goods/services, the Recipient preferably notifies the ASP 206 of the identity of the 3^{rd} party vendor 210, the amount of credits to be utilized, and other payment information. The ASP 206 then suitably transmits to the 3^{rd} party vendor 210 a payment equal to the value of the redeemed credits. This payment may be in any form including a charge to a credit card, a promissory note, a debit account, an electronic fund transfer, credits with the Administrator, or any other exchange unit. As such, the vendor 210 does not need any special processes, systems, or even an Internet connection with the ASP 206 to participate in the system 200. All the vendor 210 needs is a telecommunications link with the Administrator. In short, any vendor, in any country, providing any goods/services may be selected as the 3^{rd} party vendor 210 with whom the Recipient desires to redeem the credits. As such, as long as a communications path (cable, telephone, internet, pager, regular mail, etc.) exists between the ASP 206 and the vendor 210, the present system may be utilized.

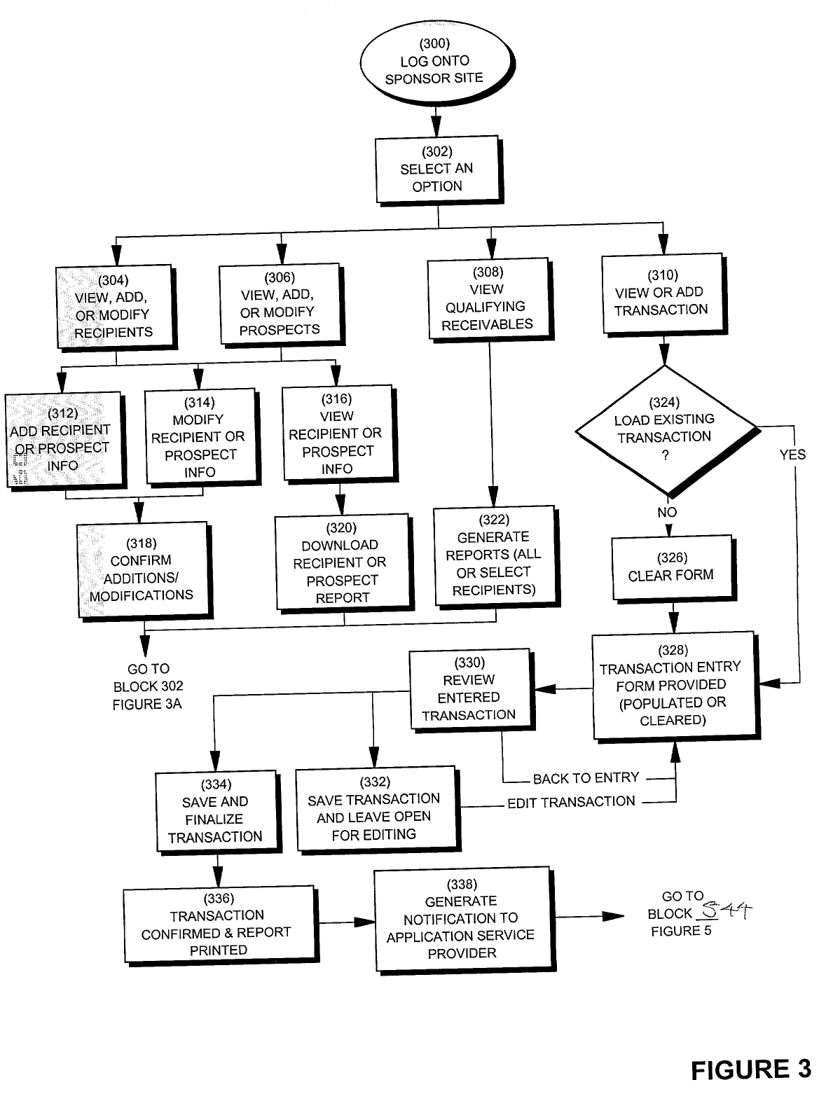

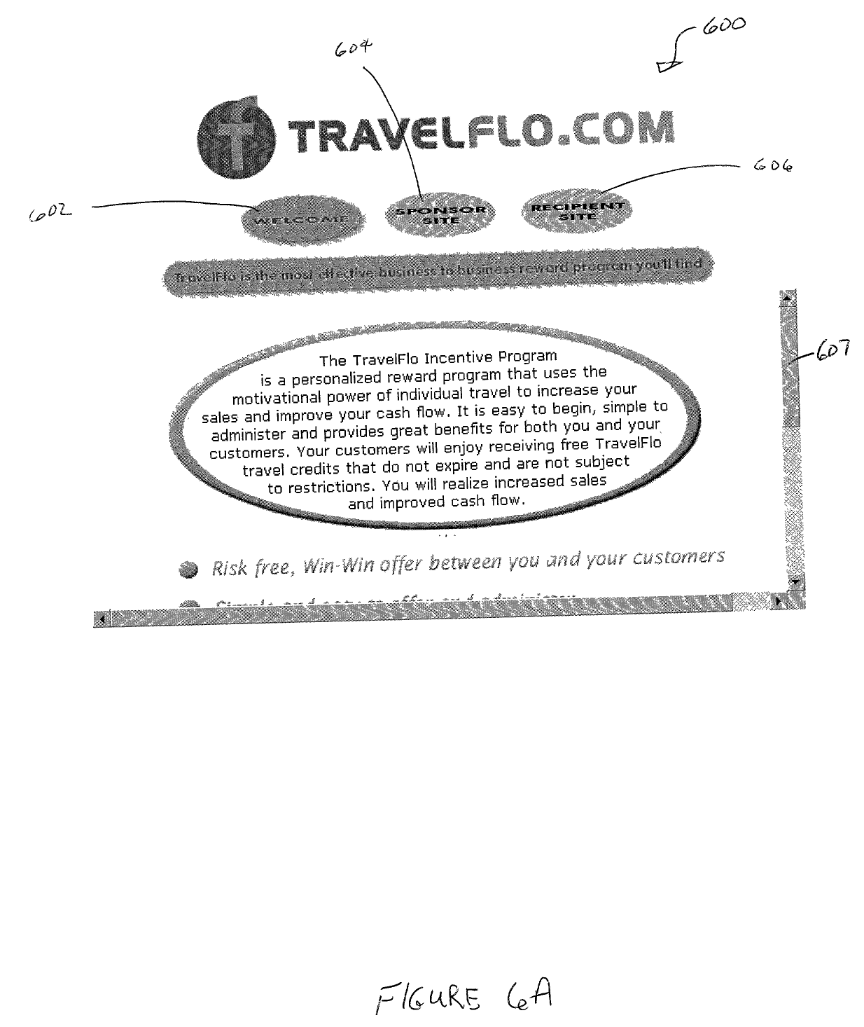

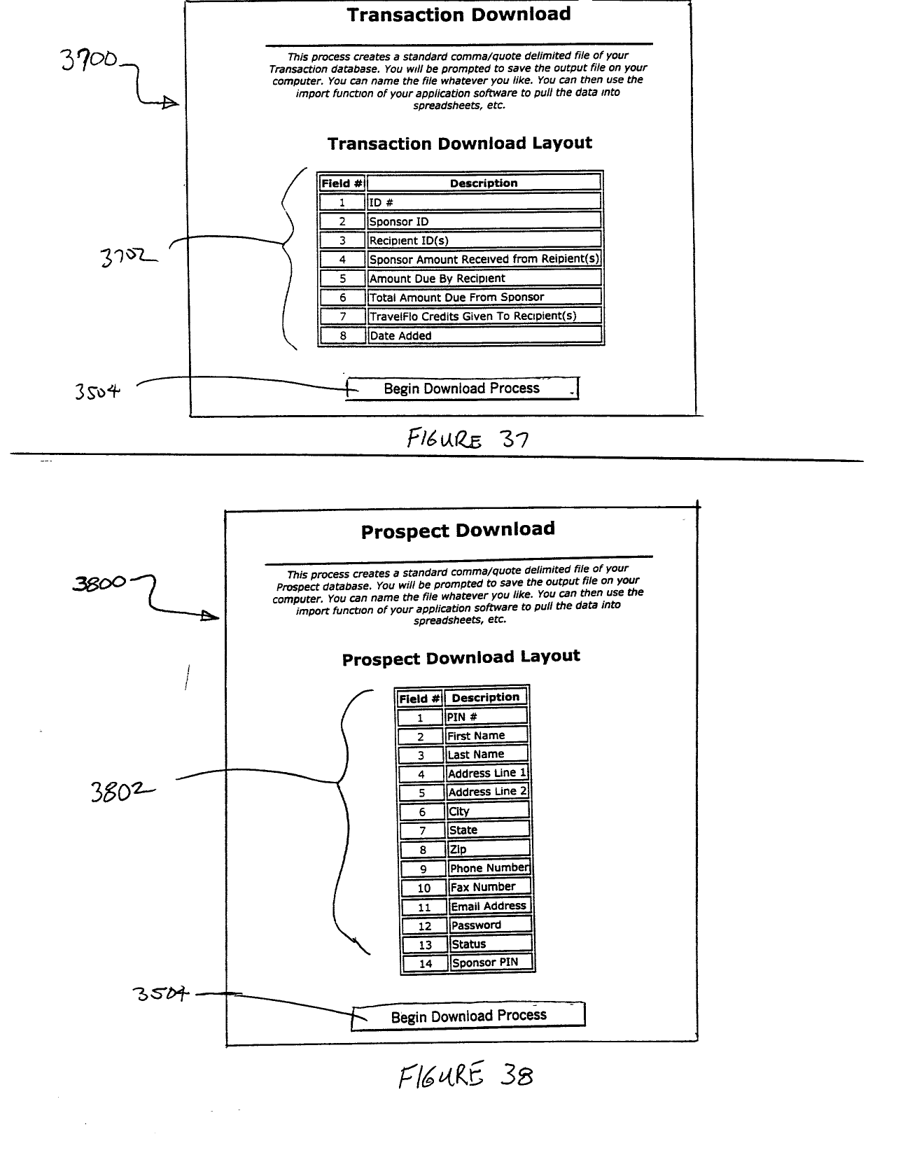

Referring now to FIGS. 3-5, the processes by which a Sponsor identifies a Recipient to receive a credit and the qualifying accounts receivables, the Recipient reviews such credits and selects credits for redemption, and the actions performed (or capable of being performed) by an Administrator are shown, respectively, for a travel credit based embodiment. Further, for purposes of illustration, FIGS. 3-5 are herein described in conjunction with FIGS. 6-45, which illustrate a software application provided by an ASP 206 for the travel credit based embodiment.

Referring now to FIGS. 6A-6C, the travel credit based embodiment provides a Home page 600 which a Sponsor or a Recipient suitably enters via the Internet or similar network connection. As shown, the Home page 600 provides basic information about the Administrator (which, for this example only, is Travelflo.Com and is referred to hereinafter as the “Site”). The page 600 provides various buttons 602, 604, and 606 which allow a user contacting the Site to suitably navigate therein. For example, when the user initially contacts the Site, the Welcome button 602 (which in this embodiment does not contain any hyper-links) is highlighted and the various other buttons and links provided on the page 600 (as further shown in FIGS. 6B and 6C) are selectable. For example, the Sponsor Site button 604 enables a Sponsor, who has already registered with the Site, to access the Sponsor related functions. Similarly, the Recipient Site button 606 allows a registered Recipient to access the Recipient related functions. Further, by utilizing the slider 607, a user may access various information about the features and functions provided by the Site, as shown in FIG. 6B. Upon a user's selection of one of the buttons 608, the data expands with additional information in the various fields 612, as shown in FIG. 6C. The Home page 600 also provides a new Sponsor with a link 610 which allows the user to register their business with the Site.

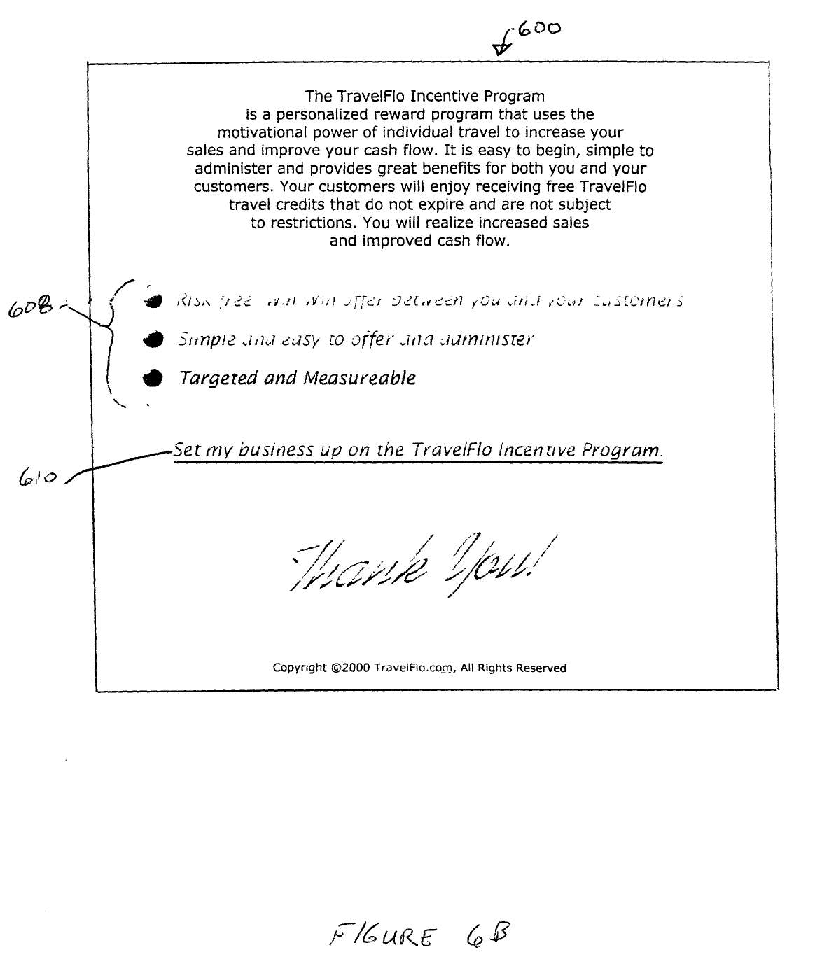

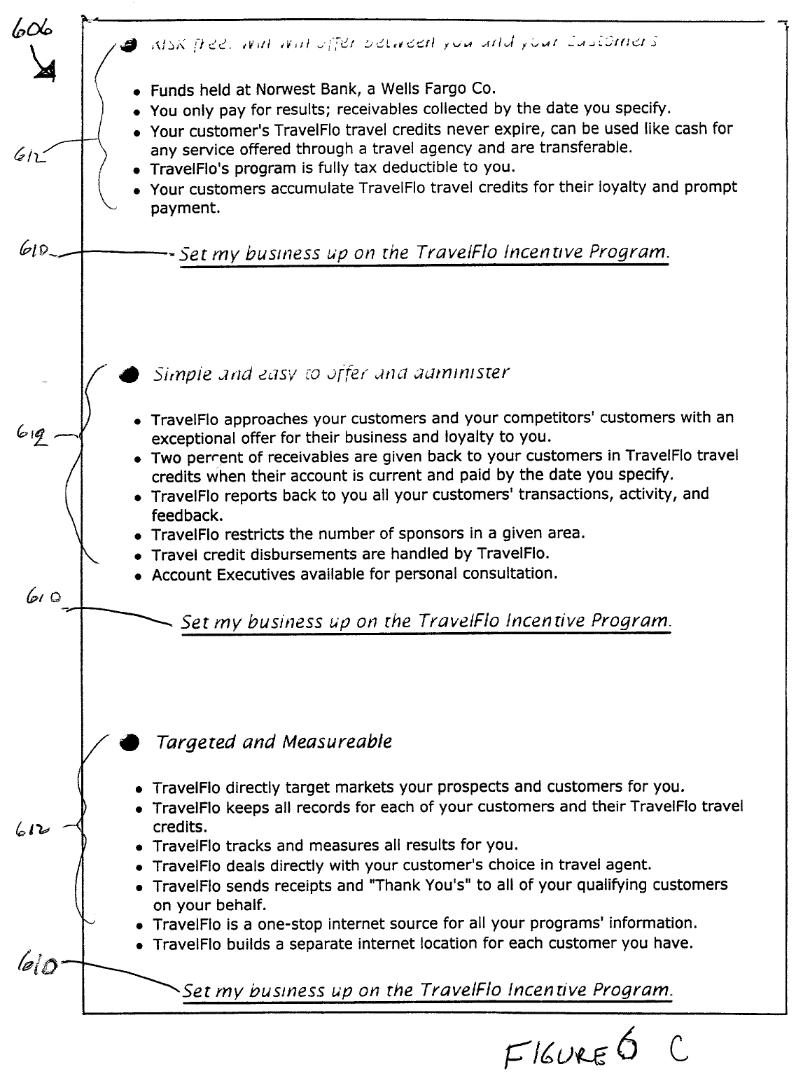

When the link 610 is selected, preferably the Sign-Up page 700 is presented to the new Sponsor, as shown in FIGS. 7A-7B (FIG. 7B is a continuation of the page presented in FIG. 7A which may be suitably accessed by scrolling down the page). This page 700 provides the Sponsor with various data entry fields 702 in which demographic information may be entered. It also provides a box 704 in which the Sponsor specifies when payment must be received from a Recipient in order for the Recipient to be eligible to receive credits. In this embodiment, the credit level is automatically set at 2% of qualified receivables and such credits are to be used for travel. However, as mentioned previously, the present invention is not so limited and any threshold amount, triggering event, or redemption scheme may be utilized, as desired, in this or other embodiments. The page 700 also requires the new Sponsor to input a password in fields 706. The password is utilized to secure and limit access to the database, features, and functions of the Site. Other security systems, which are well known in the art, may also be utilized by the present invention.

Upon entering the required data in the various data fields, the Sponsor then selects the Submit and Print button 708 which suitably registers the Sponsor with the Site. In this embodiment, a $200 deposit is required before a Sponsor may utilize the features and functions of the Site. Preferably, such deposit is provided via a check or credit card number, however, those skilled in the art appreciate that the deposit may be excluded altogether (and the Sponsor may then become a creditor of the Site), or alternative methods of payment may be utilized, for example, direct deposit and electronic file transfers.

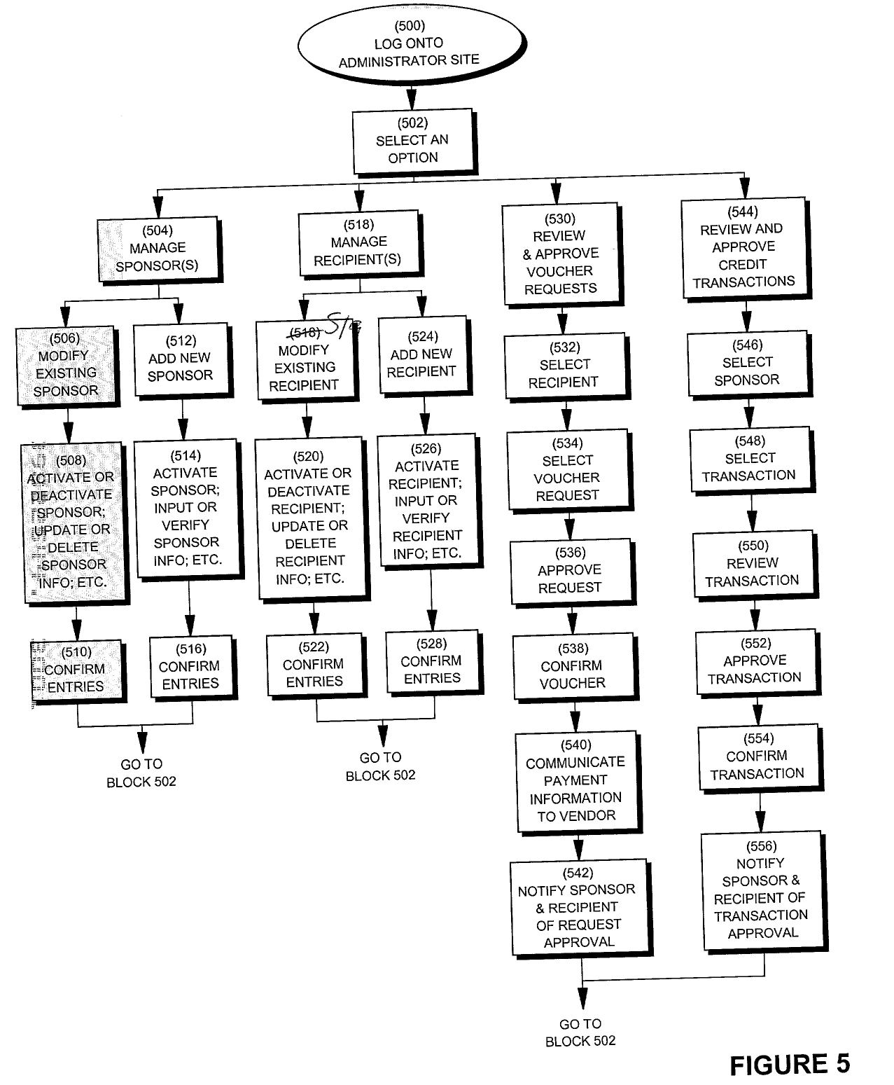

After the Submit and Print button 708 is selected, processing of the new or modified Sponsor information suitably falls into the Administrator's realm. As shown in FIG. 5, the new or modified Sponsor information processing preferably follows the steps of receiving the new or modified Sponsor information and activating, deactivating, updating, or deleting Sponsor information from a database controlled and/or administered by the Administrator via the ASP (Steps 504-510 and 504-516, FIG. 5). Those skilled in the art appreciate that the process by which information is accessed and/or stored by the ASP may vary depending upon various factors such as whether the storage medium is local or remote, the system processing capabilities and similar variables.

Further, FIG. 7C illustrates a sample email which is preferably sent by the Site to an Administrator notifying them of a new Sponsor sign-up. In this embodiment, the Administrator must approve the sign-up information before the Sponsor is allowed full access to the Site. However, it is to be appreciated that automated Sponsor verification systems may be utilized, as desired, by various other embodiments. Such automated verification and sign-up systems are well known in the art.

Once a Sponsor has been signed-up with the Site, the Sponsor is preferably notified via email of such status and is provided with a pin #. At this point, when the Sponsor reestablishes a connection with the Home page 600 (as shown in FIG. 6A) and selects the Sponsor Site button 604, the system preferably displays the Welcome Sponsor page 800, as shown in FIG. 8. The Sponsor then logs onto the Sponsor site by inputting the correct pin # and password in the data fields 802 and selecting the Go button 804 (Step 300, FIG. 3).

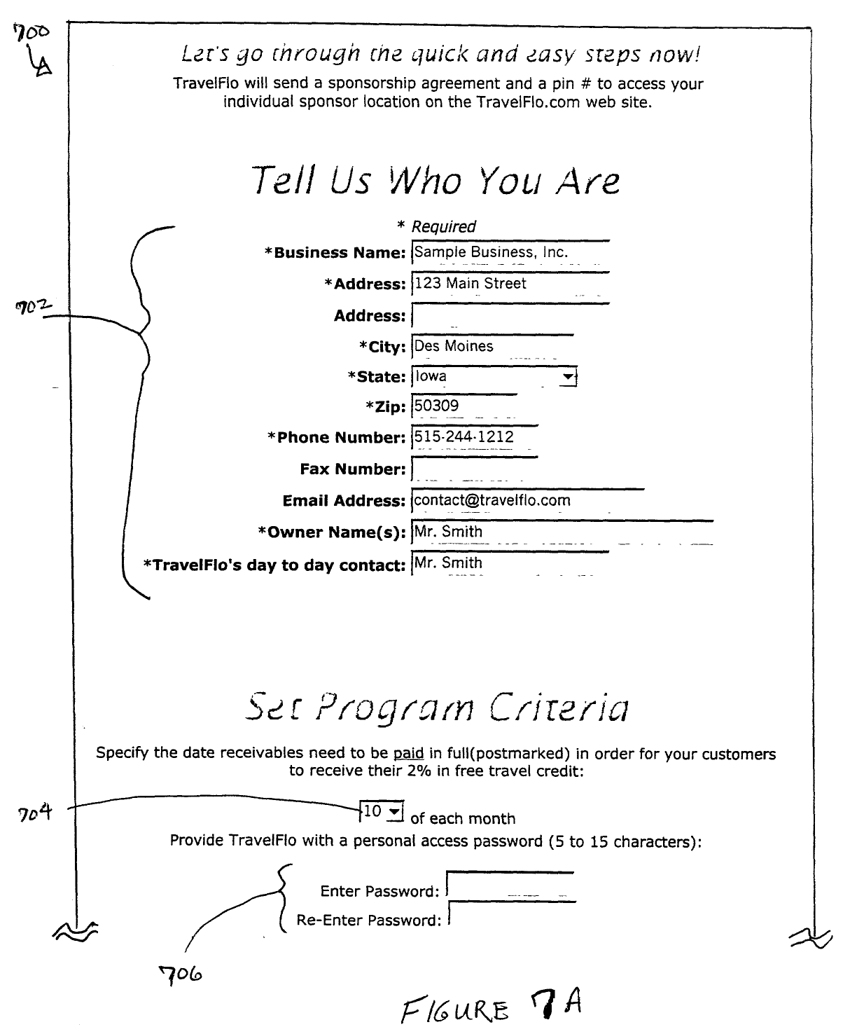

Assuming the Sponsor entered the correct pin # and password, the system then presents to the user the Welcome Back Sponsor page 900, as shown in FIG. 9. For purposes of the present example, the Sponsor is assumed to be named “Sample Business, Inc.”. This page 900 provides the Sponsor with four options selectable via hyper-links: My Customer List 902, My Prospect List 904, My Qualifying Receivables 906, and View/Add Transactions 908. Each of these options is discussed in greater detail herein. The Sponsor then selects one of the four options (Step 302, FIG. 3).

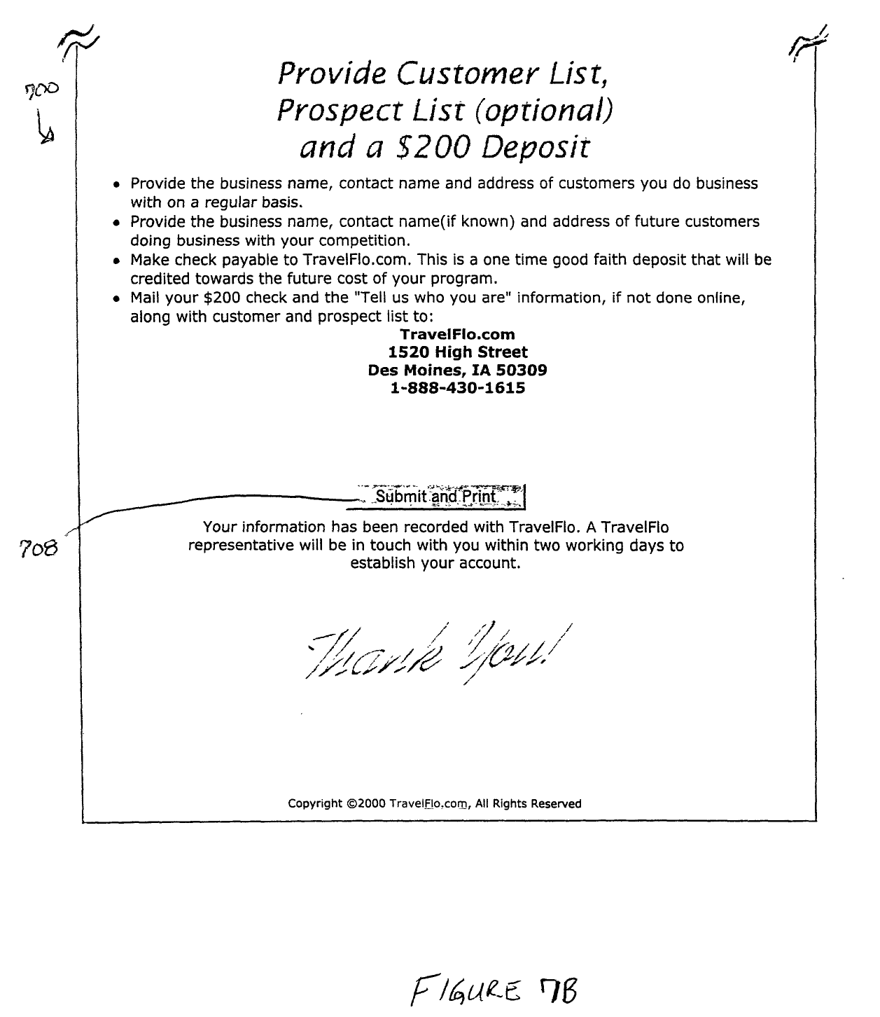

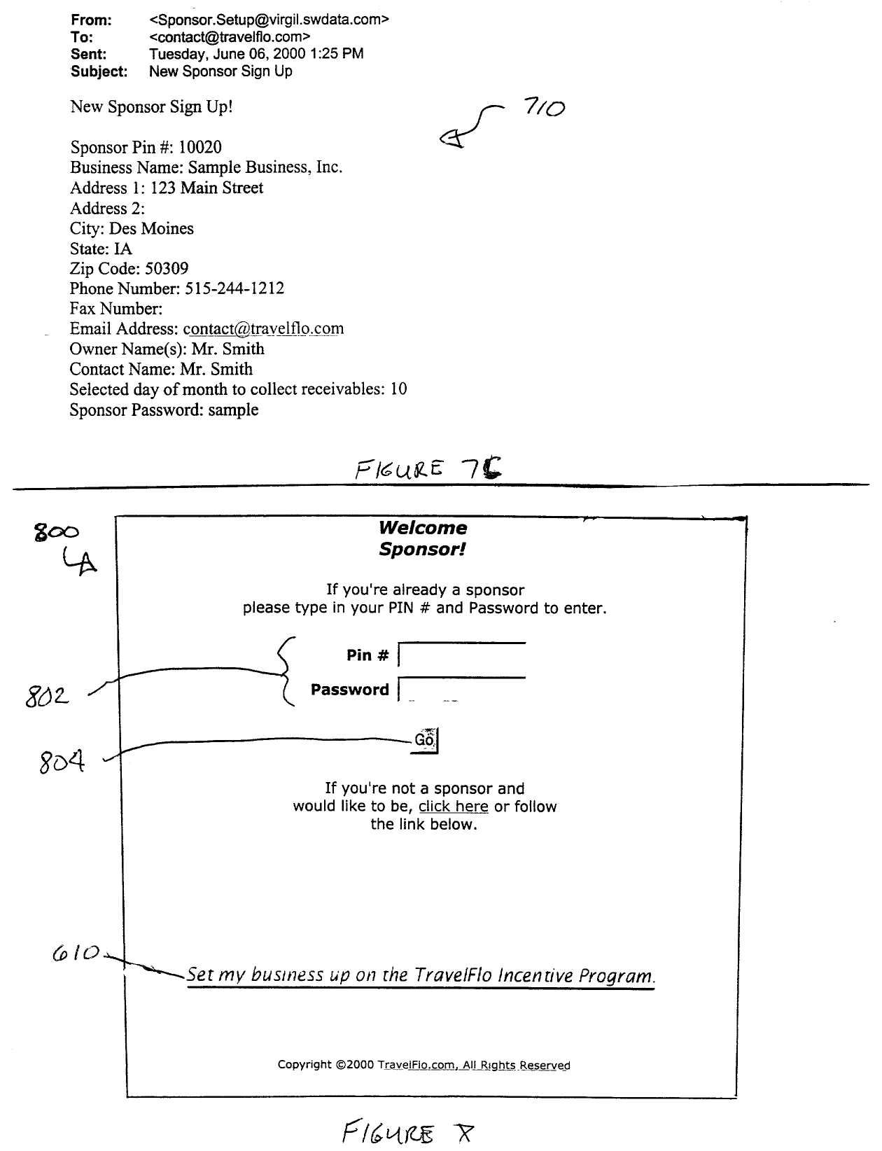

When the My Customer List button 902 is selected (Step 304, FIG. 3), the Site presents the My Customer List page 1000, as shown in FIG. 10. This page 1000 provides the Sponsor with a data entry field 1002 in which the name of an existing Recipient may be entered (i.e., one who has already been identified by the Sponsor to the Site). New information may be provided for the Recipient upon selecting the Modify button 1004 (Step 314, FIG. 3). Similarly, a New button 1006 is provided which enables a Sponsor to input information for a new Recipient (Step 312, FIG. 3). When either the New button 1006 or the Modify button 1004 is selected, the Site preferably displays a web page containing a data entry field 1102 in which data for a Recipient may be entered (as shown in FIGS. 11A and 11B, FIG. 11B showing populated fields). Entered information is suitably confirmed and stored by the Site in a database (which may be either local or remote to the Site) upon the Sponsor selecting the Update Customer button 1104 (Step 318, FIG. 3). The close button 1007 (as shown in FIG. 10 and 11A & B) suitably returns the Sponsor to Welcome Back Sponsor page 900 (Step 302, FIG. 3).

As provided for the Sponsor modification and adding features previously mentioned herein, the present embodiment further allows Administrators to control and/or manage the adding, modifying, updating, and deleting of Recipient information as shown in FIG. 5. More specifically, when information pertaining to an existing Recipient is to be modified, the ASP preferably follows steps 519-522. Similarly, when a new Recipient is to be added, the ASP preferably follows steps 524-528.

Further, the My Customer List page 1000 also provides the Sponsor with the option of downloading a complete listing of Recipients maintained in the Site's databases by selecting the Download My Customer List Now button 1008 (Step 320, FIG. 3). In this embodiment, the Site then provides a text file containing a listing of the Recipients in the database for the Sponsor. Since the list is provided as a text file without hyper-links embedded therein, the Sponsor is not allowed to access the Recipient information directly from the list. Instead the Sponsor must first enter the Recipient's name in the field 1002, as discussed previously. However, the present invention is not so limited and may be configured, when desired, to provide an interactive Recipient list which contains, for example, hyper-links or URLs that allow the Sponsor to directly access Recipient information by selecting a name on the list. Further, additional information may also be included in such Recipient lists, as desired, including links to Sponsor information, links to Recipient provided web pages, or other information. The incorporation, presentation, and accessing of such information is well known in the art, and is not discussed further herein.

After a Recipient has been modified or added to the Sponsor's list, the Site suitably presents the Customer Added page 1200 identifying the Recipient's name, a pin #, and a password which the Recipient will utilize to access the Site, as discussed below (FIG. 12). In this embodiment, the Sponsor is responsible for notifying the Recipient of their pin # and password. However, those skilled in the art appreciate that the present invention may be configured such that notifications to the Recipient are automatically provided by the Site and require no actions by the Sponsor. Such notifications may include “door prizes” which encourage the Recipient to access the Site and thereby provides an additional opportunity to market the Site and the Sponsor.

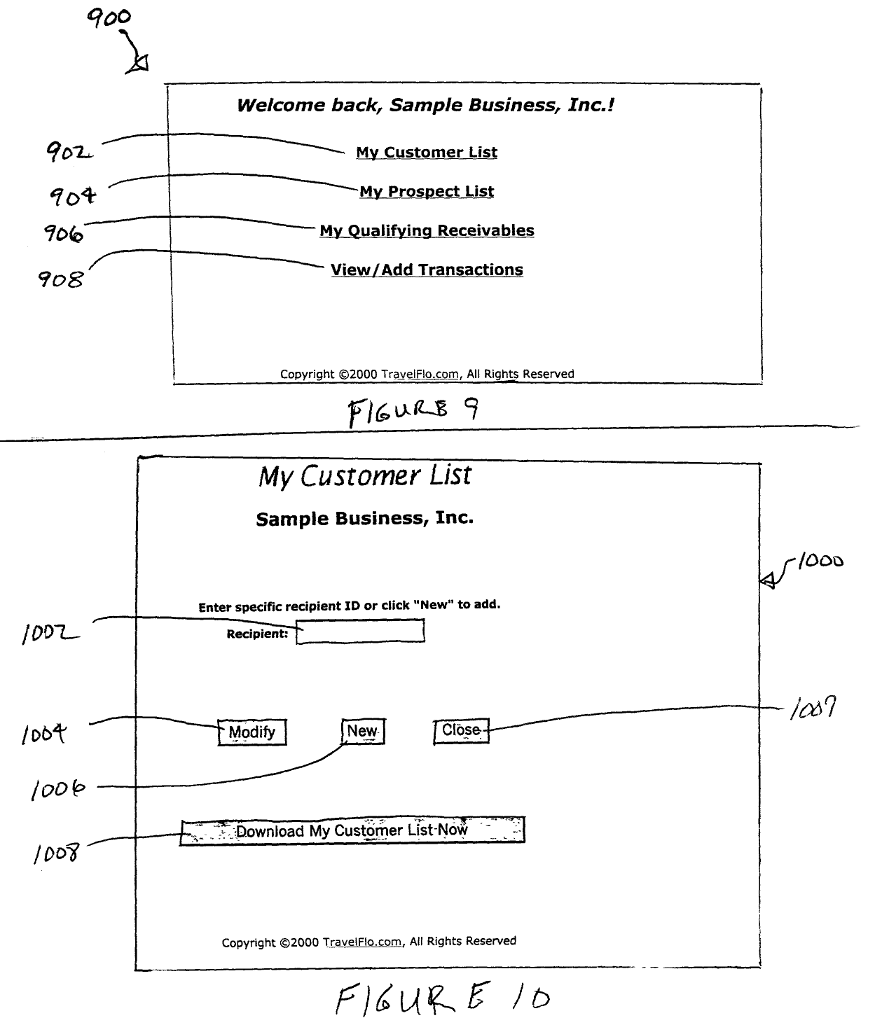

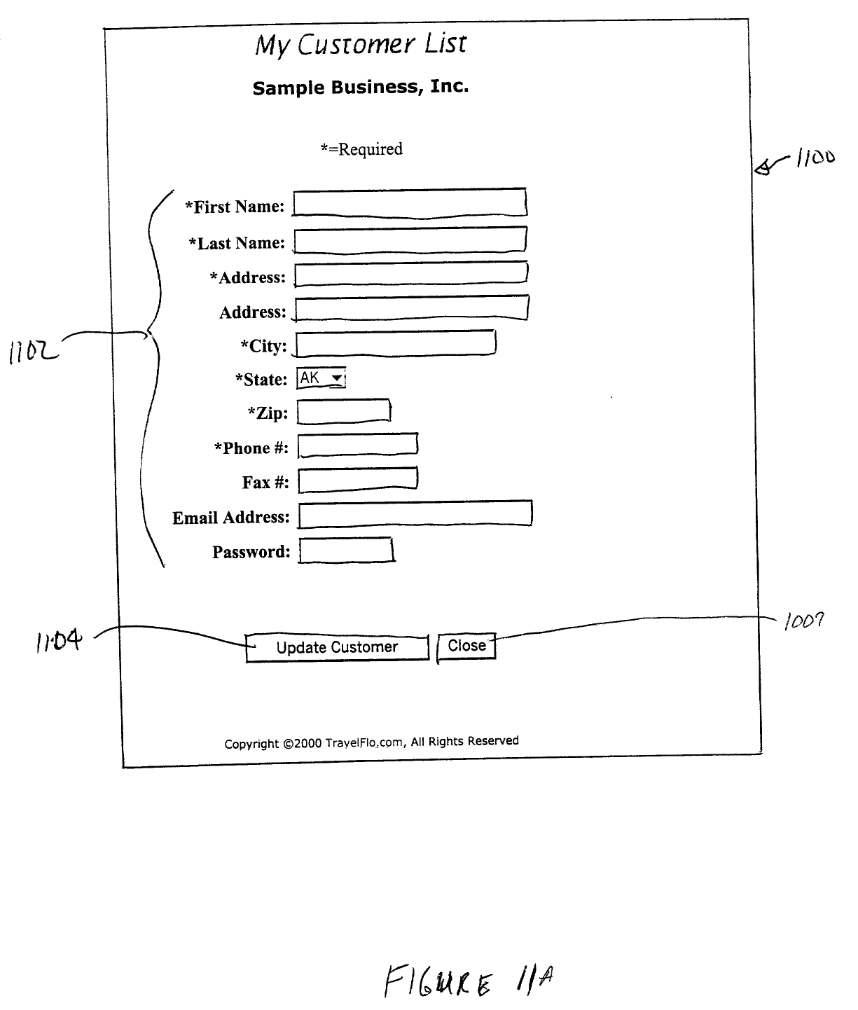

This embodiment also enables a Sponsor to identify potential customers (“Prospects”) to the Site, so that marketing information may be communicated to them. When the Sponsor selects the My Prospect List link 904 on the Welcome Back page 900 (FIG. 9), the Site displays the My Prospect List page 1300, as shown in FIG. 13 (Step 306, FIG. 3). As provided for the My Customer List page 1000, the My Prospect List page 1300 allows the Sponsor to modify Prospect information and add new Prospects (via buttons 1304 and 1306, respectively and field 1402), and download a list of Prospects (via button 1308), as shown in FIGS. 13 and 14. Additionally, when a Prospect is to be transferred to Recipient status, a pin # and password are provided, as shown in FIG. 15.

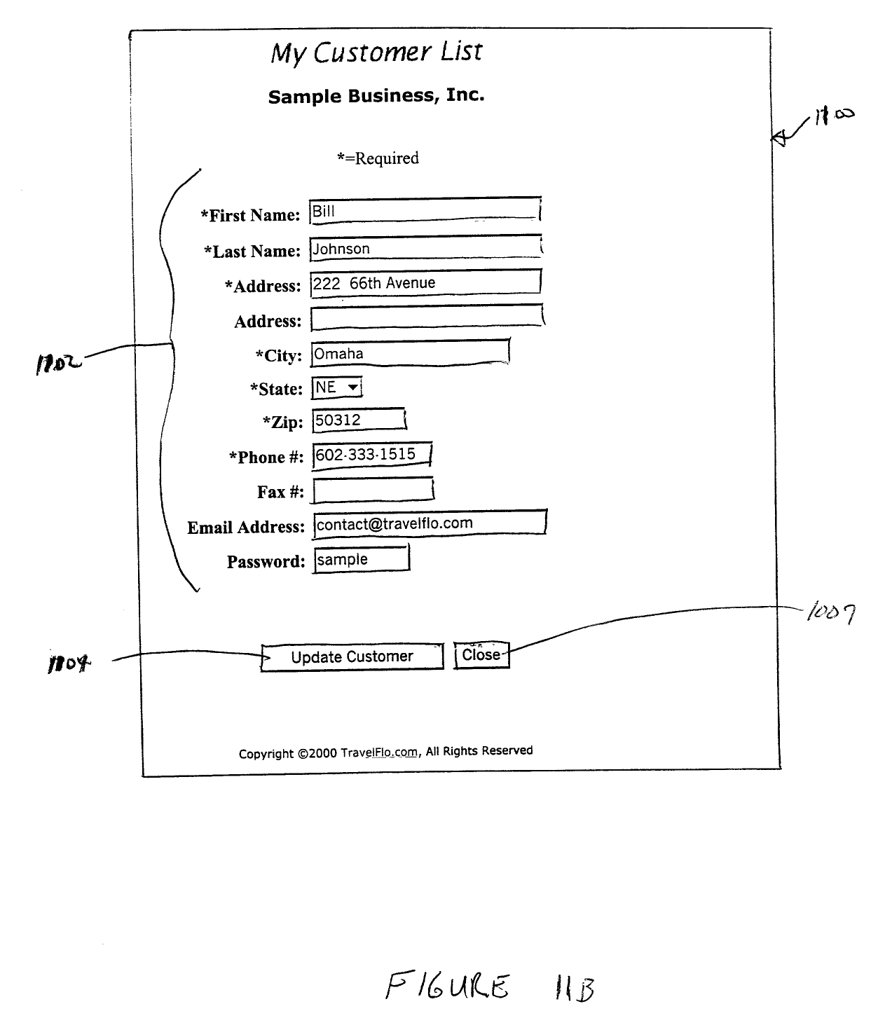

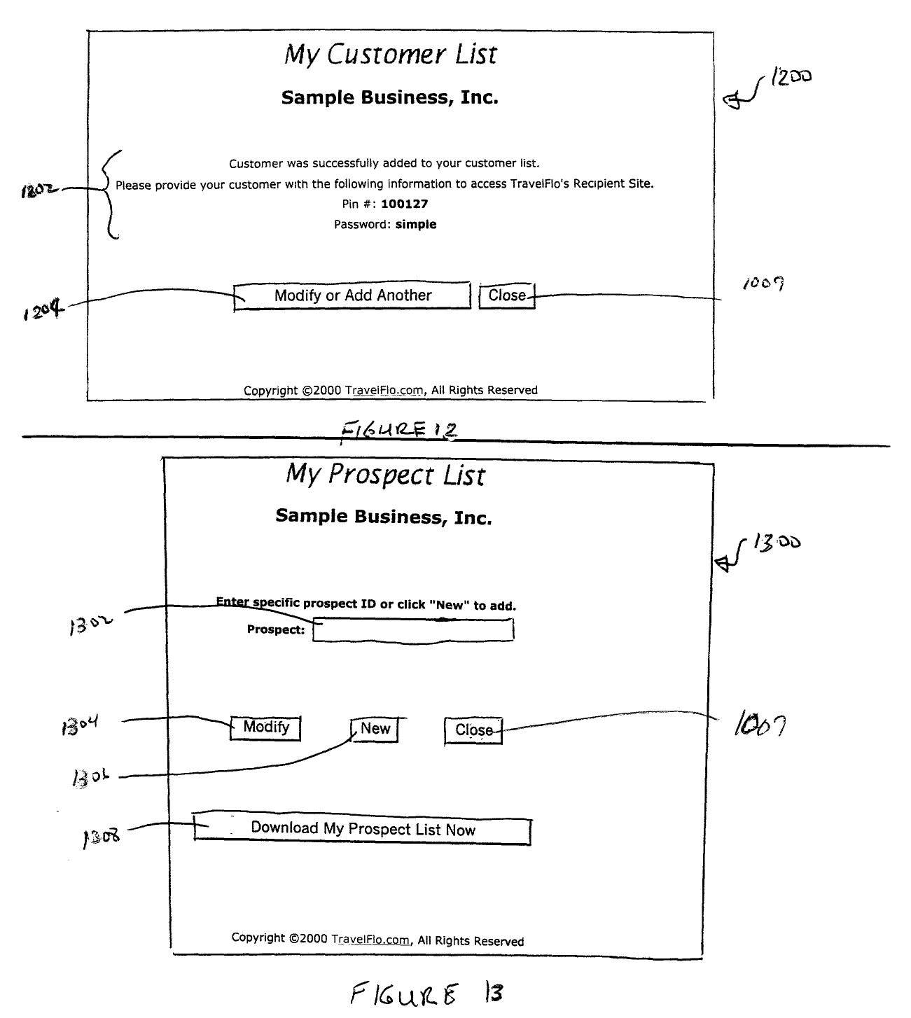

Referring again momentarily to FIG. 9, when a Sponsor selects the My Qualifying Receivables link 906, the Site displays the My Qualifying Receivables page 1600, as shown in FIG. 16 (Step 308, FIG. 3). This page 1600 provides a Sponsor with the option of viewing qualifying receivables by a single Recipient or all Recipients via a data field 1602 and the Submit button 1604. Based upon whether all or a specific recipient has been specified, the Site then populates and presents the Report page 1700, as shown in FIG. 17 (Step 322, FIG. 3). The Report page 1700 provides historical information about the receivables posted to the Site by the Sponsor. By selecting the Back button 1702, the Sponsor may direct the Site to return to the My Qualifying Receivables page 1600 for entry of another identifier of a specific Recipient or all Recipients.

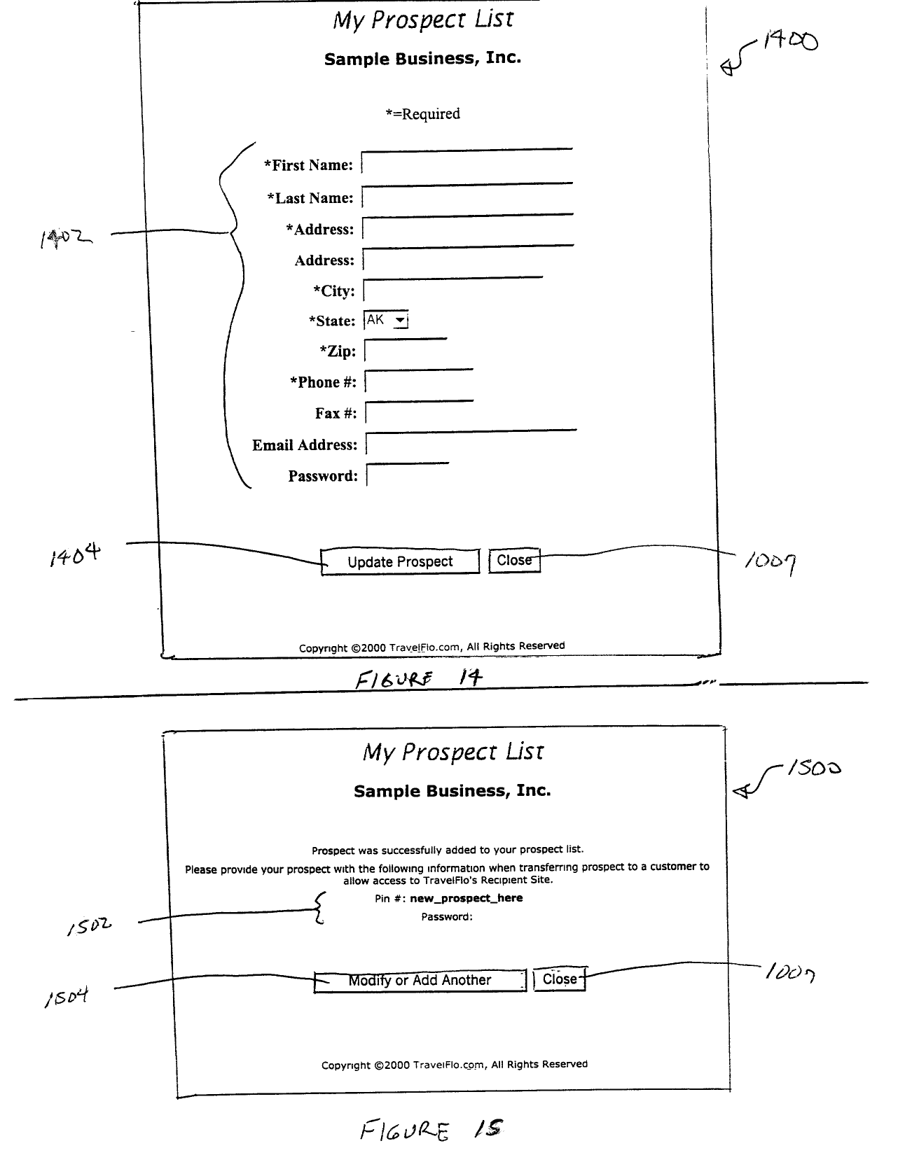

Referring again to FIG. 9, when the Sponsor selects the View/Add Transactions link 908, the Site preferably displays the Transaction Entry page 1800, as shown in FIG. 18 (Step 310, FIG. 3). Preferably, a Sponsor accesses this feature of the Site on a monthly basis to identify those customers whose receivables qualify for credits. However, other periods may also be used. This page 1800 provides the Sponsor with two options: the Sponsor may Clear Form and Start New (via button 1802) or Load Existing (via button 1804) (Steps 324-328, FIG. 3). When the first option is selected (i.e., the Clear Form and Start New button 1802), the Site provides a blank data entry field into which the Sponsor may enter transaction data. FIG. 19 illustrates one example of the Transaction Entry Field page 1900 in which transaction data has been previously entered (Step 330, FIG. 3).

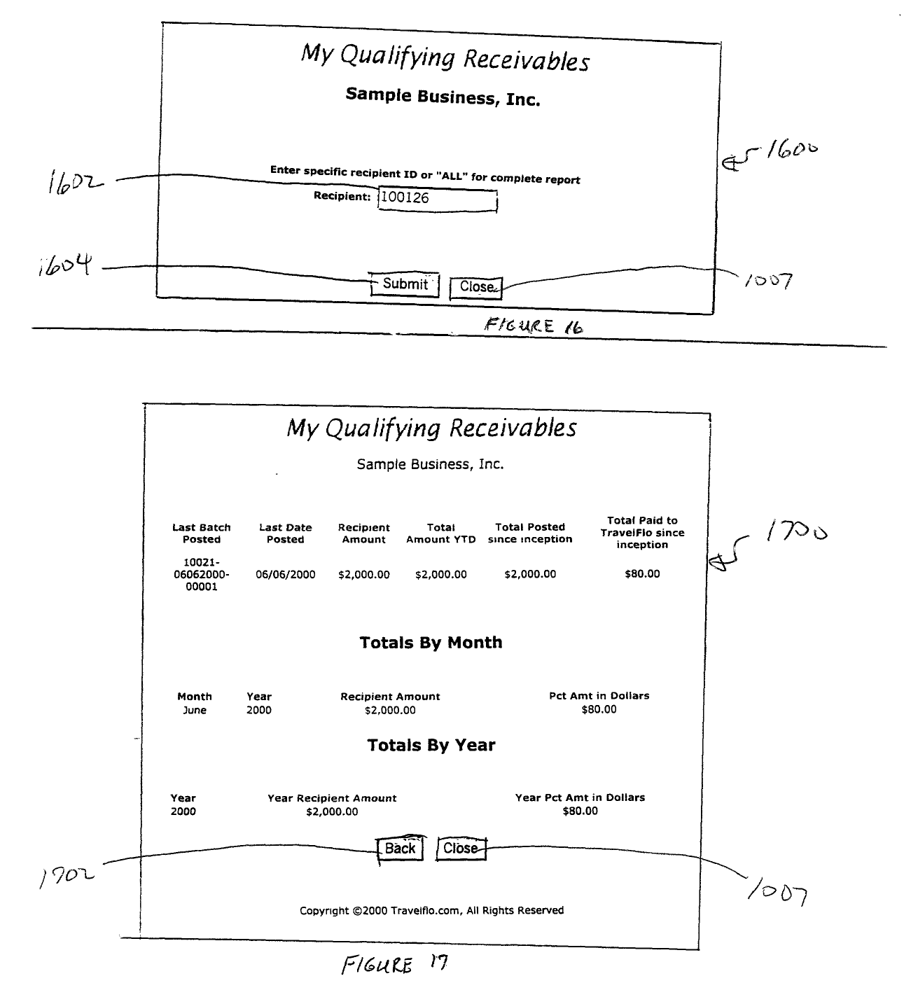

As shown in FIG. 19, this page 1900 provides a Clients Listing field 1902 in which Recipients (i.e., customers) are listed for selection and an Add Client to Transaction button 1906 which, when selected, adds a selected client to a particular transaction. Additionally, this page 1900 provides various fields 1904 into which batch identification numbers, client data, and qualifying receivables are entered by the Sponsor. The Paid to Travelflo column is suitably calculated by the Site. Once this data is entered into the page 1900, the Sponsor suitably selects the Review button 1910, and the Site then preferably displays the Transaction Review page 2000, as shown in FIG. 20A.

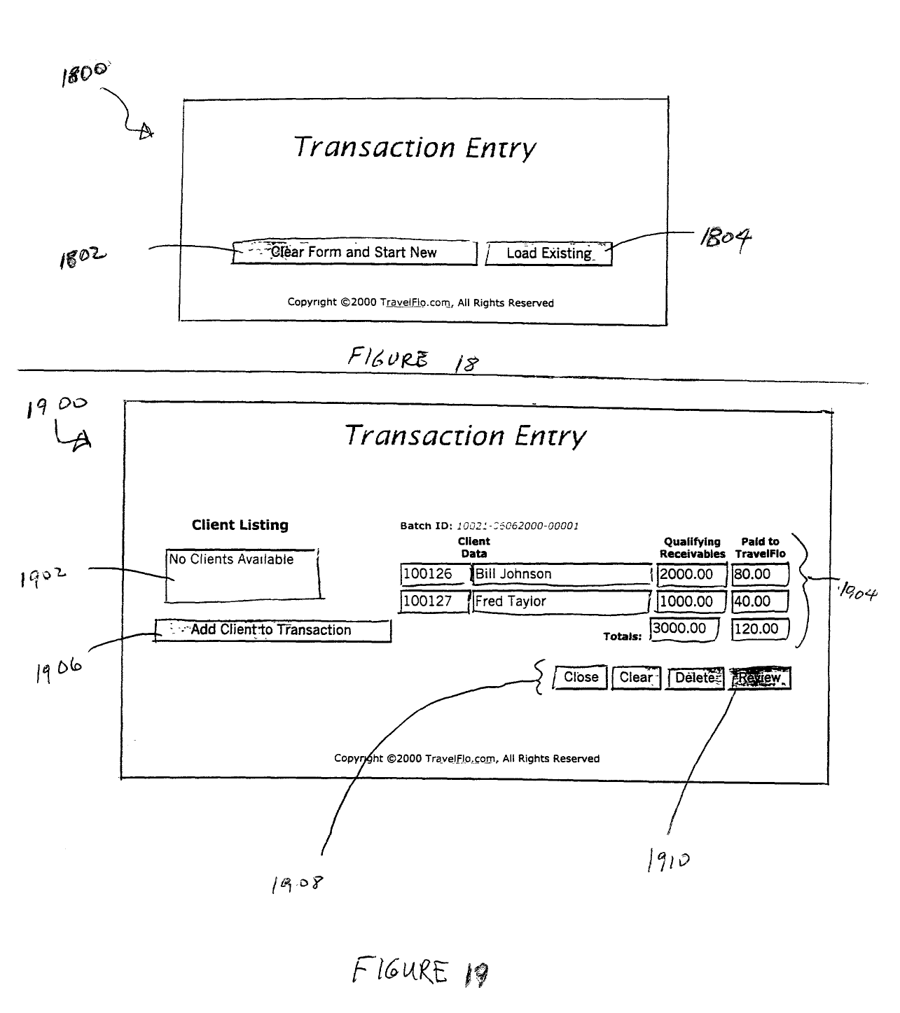

As shown in FIG. 20A, the Transaction Review page 2000 provides a data field 2002 in which information about the previously entered transaction is presented. The page 2000 also provides the Sponsor with the options of Save and Leave Open 2004, Save and Finalize 2006 and Back to Entry 2008 via the corresponding buttons. The Save and Leave Open option 2004 allows the Sponsor to retrieve the entered data at a later time without finalizing the transaction and thereby generating credits for a Recipient (Step 332, FIG. 3). When the Save and Finalize button 2006 is selected, the Site creates an invoice, as shown in FIG. 20B. Upon the Sponsor selecting the Save and Finalize button 2006 a second time (FIG. 20B), the Site saves the entered transaction data, generates a notice to the Site Administrator to approve the credits generated by the transaction, and displays a message informing the Sponsor that the batch has been successfully processed, as shown in FIG. 21 (Steps 334-338, FIG. 3). When the Sponsor selects the Done button 2102, the Site preferably returns to the Sponsor page 900, as shown in FIG. 9, from which the Sponsor may then perform any of the before mentioned tasks for the same or different Recipients. As such, the Site preferably provides the Sponsor with a series of displays and options for identifying recipients and qualified receivables. In the present embodiment, such identifications are performed via manual input, however, it is to be appreciated that such identifications of Recipients, Prospects, qualifying receivables, and transactions may be accomplished automatically. Those skilled in the art appreciate the various data transfer protocols and programs which may be utilized to perform an automated file transfer or download of such information.

Additionally, when the transaction request has been completed and submitted by the Sponsor to the Administrator, the process preferably continues with the Administrator reviewing and approving each credit transaction, as shown in FIG. 5, Step 544. This process of reviewing and approving a transaction request requires the Administrator (either manually, semiautomatically, or automatically) to access and select the Sponsor from the database (Step 546), select the transaction (Step 548), review the transaction (Step 550), approve the transaction (Step 552), confirm the transaction (Step 554) and notify both the Sponsor and the Recipient of the approved transaction (Step 556). As mentioned previously, such notifications may be accomplished using any communications medium(s) available and/or desired by the Sponsor, the Recipient, and/or the Administrator.

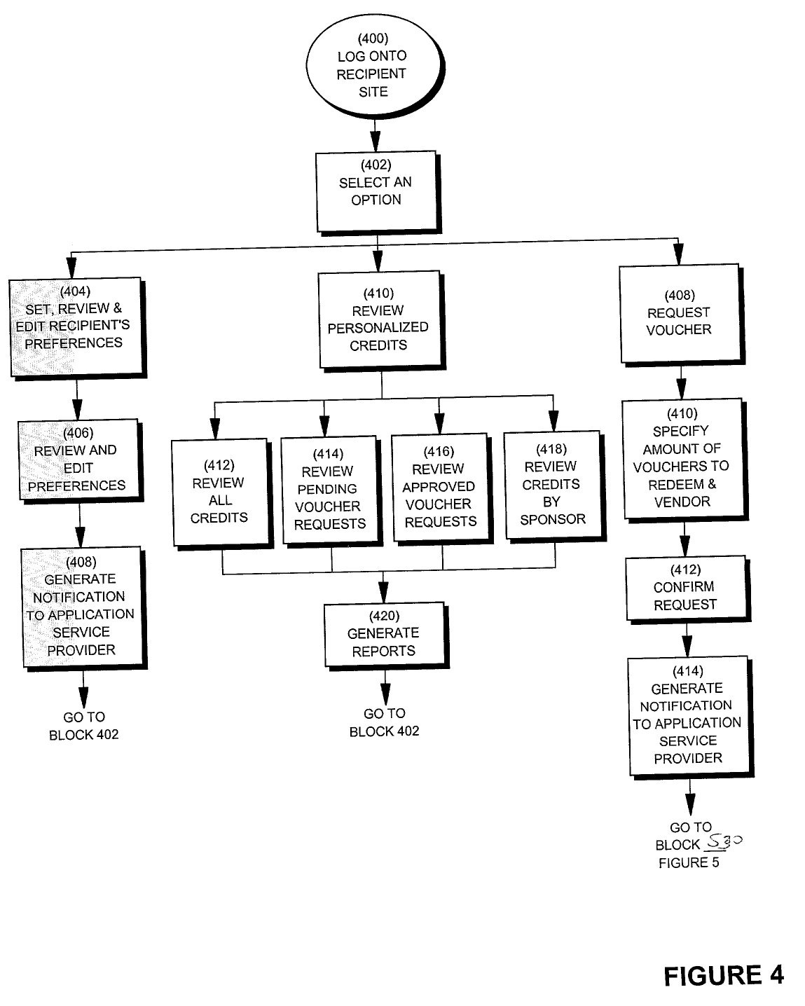

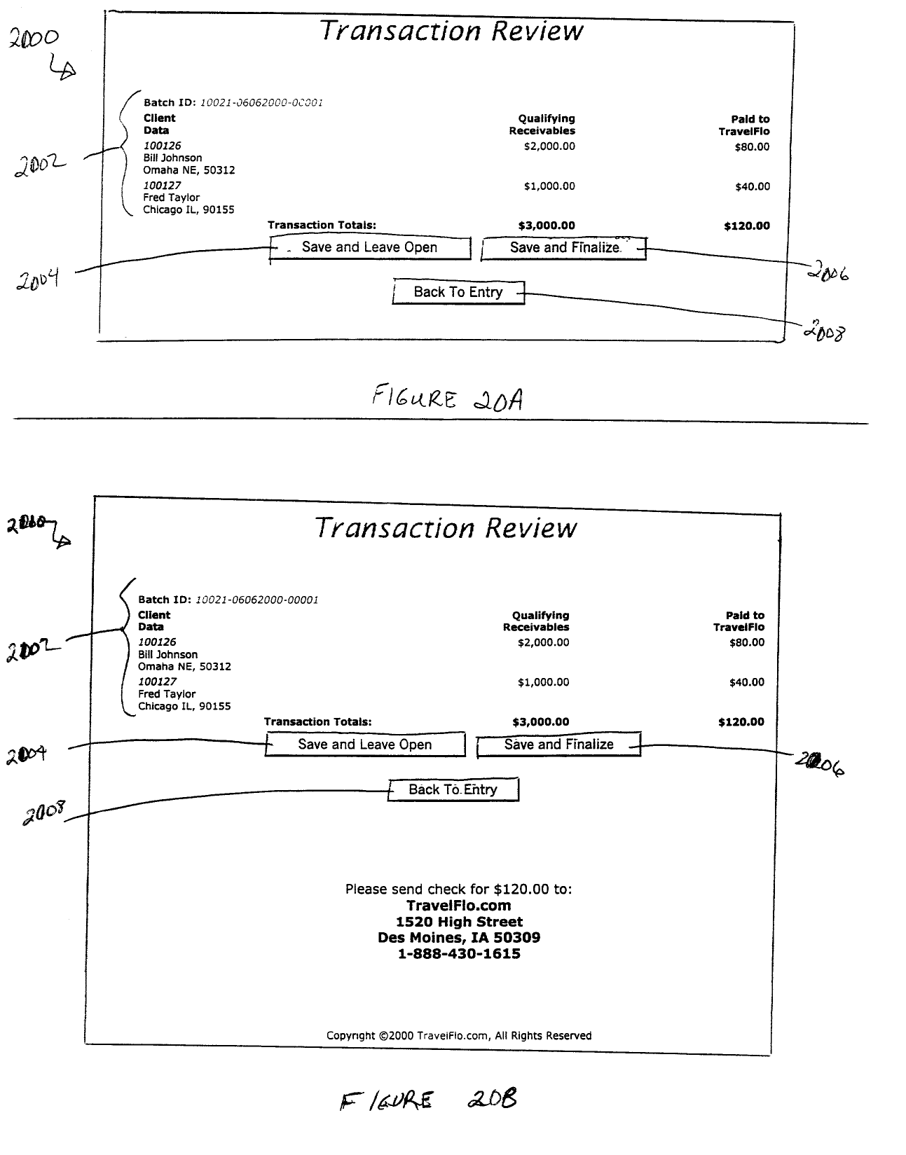

Referring now to FIG. 6A and FIG. 4 (which illustrates the process by which a Recipient reviews and redeems credits), when a Recipient establishes an Internet connection with the Site, the Recipient is preferably presented with the Home page 600. When the Recipient Site button 606 is selected, the Site preferably displays the Welcome Recipient page 2200, as shown in FIG. 22. This page 2200 provides entry fields 2202 in which the Recipient provides a pin # and a password and a Go button 2204 for initiating a session (Step 400, FIG. 4). It is to be appreciated, however, that other Recipient identification features may also be utilized in conjunction with the present invention, such as search features used to identify a recipient who has forgotten their password or pin number, voice recognition systems, and similar systems.

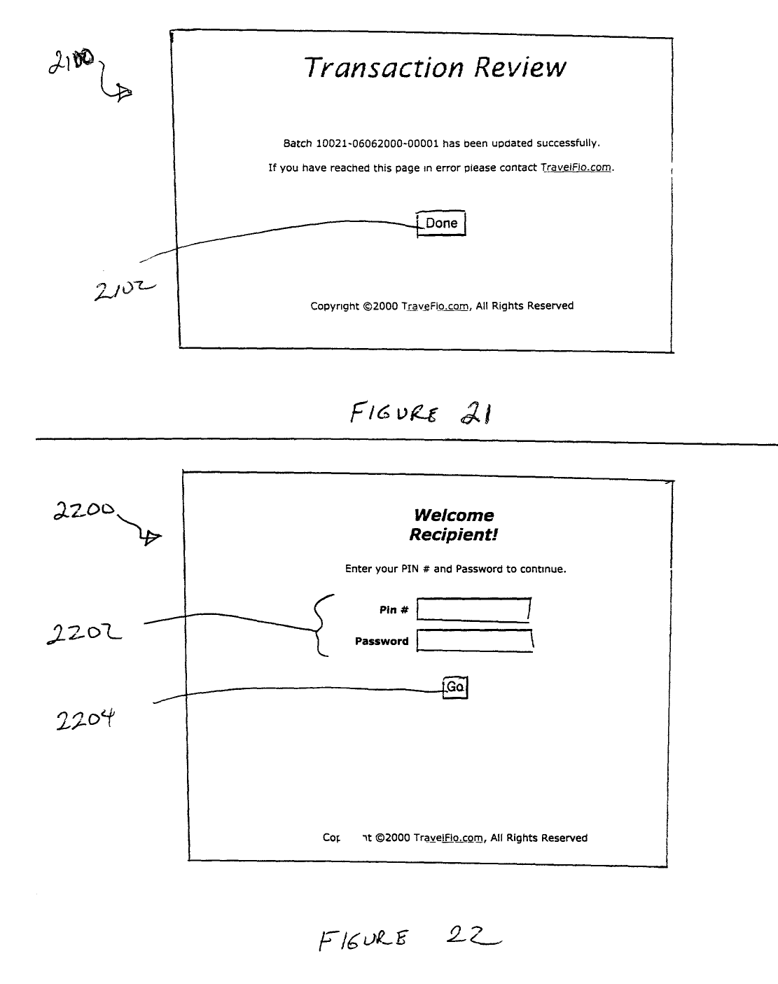

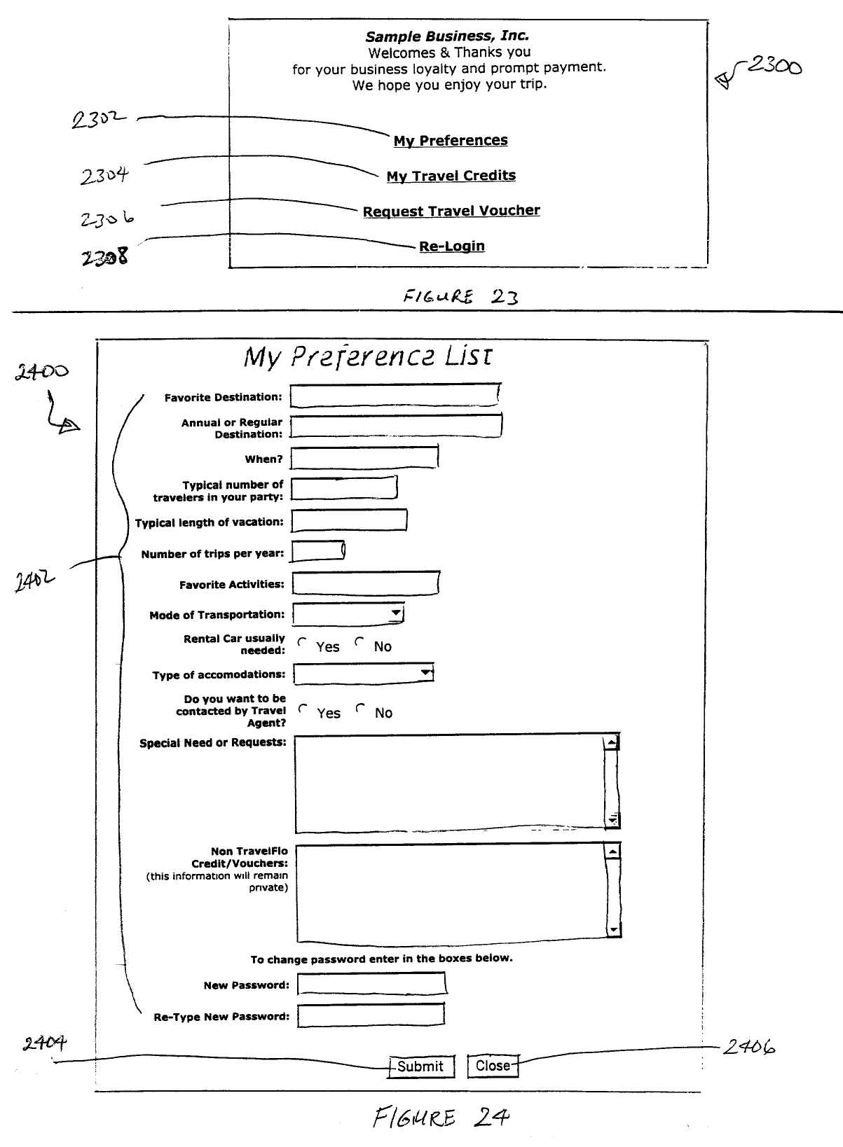

After the Recipient has logged onto the Site by supplying the correct pin number and password, the Recipient Options page 2300 is presented, as shown in FIG. 23. This page 2300 provides the Recipient with four options via the corresponding links (2302, 2304, 2306, and 2308).

Upon selection of the first option, the My Preferences link 2302, the Site presents the Recipient with the My Preferences List page 2400, as shown in FIG. 24. This page 2400 provides a field 2402 in which the Recipient provides information regarding travel destinations, frequency and other parameters (Steps 404-408, FIG. 4). As discussed previously, the preferred embodiment preferably rewards travel credits which are then redeemed by a Recipient to offset the costs of travel. However, other embodiments may be configured to award credits based upon accounts receivables performance for other incentives such as the purchase of goods, theater discounts, skiing lift tickets, and other incentives. Further, the Recipient may update preferences as desired at any time by selecting the My Preferences link 2302, inputting the new information, and then selecting the Submit button 2404. Upon selection of either the Submit button 2404 or the Close button 2406, the Site preferably returns to the Recipient Option page 2300.

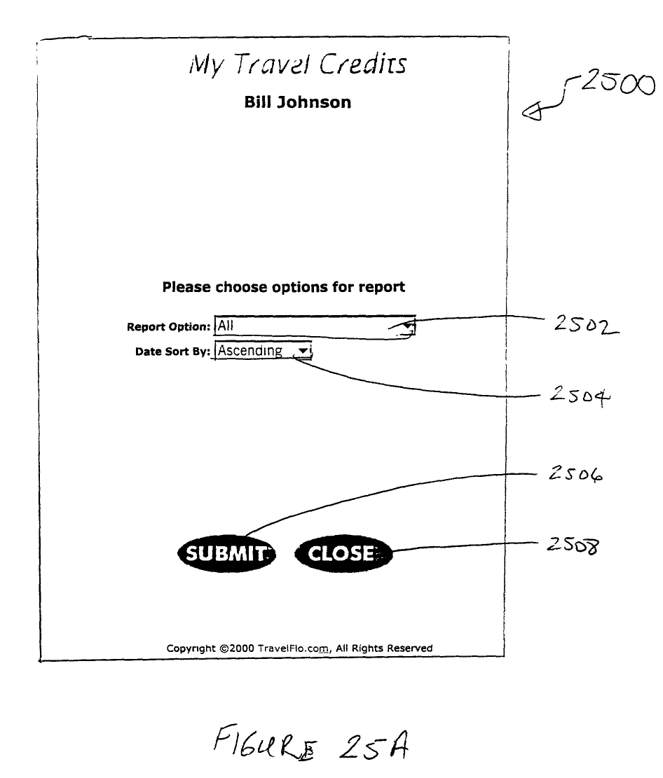

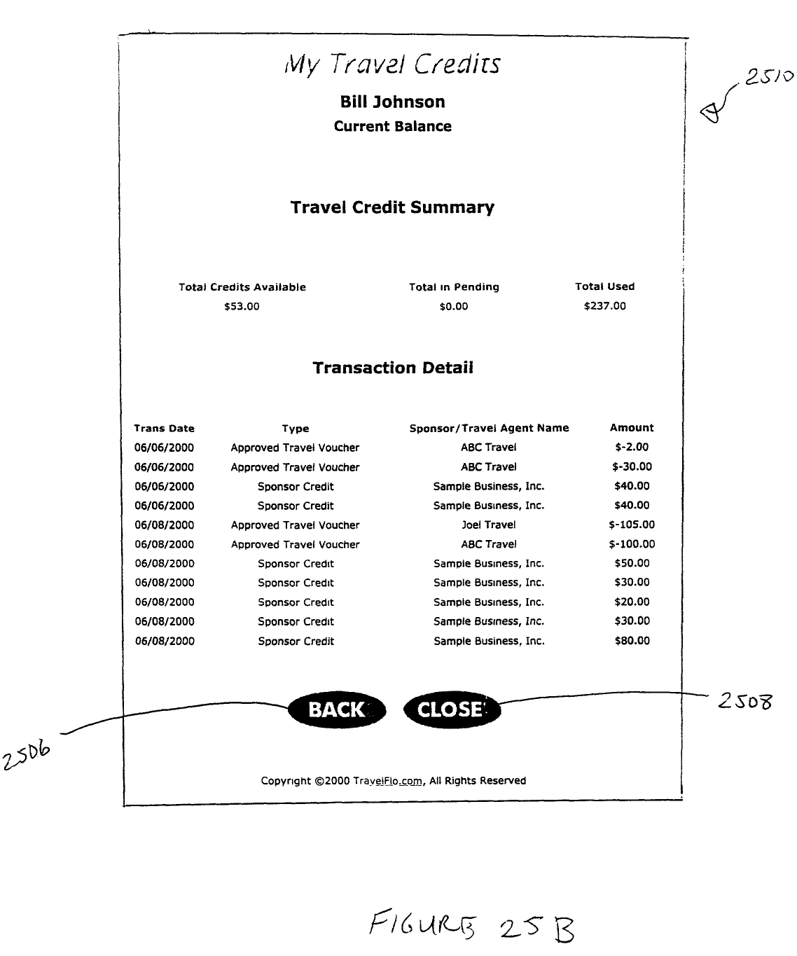

Referring again to FIG. 23, when the Recipient selects the second option, the My Travel Credits link 2304, the Site presents the My Travel Credits page 2500, as shown in FIG. 25 (Step 410, FIG. 4). As shown in FIG. 25, this page 2500 presents the Recipient with a Report Option field 2502, which presents the Recipient with four options for viewing reports. The options are: (1) to view All credits; (2) to view Pending Voucher Requests; (3) to view Approved Voucher Requests; and (4) to view credits By Sponsor. As shown in FIG. 25A, the All reports option has been selected. When the Recipient selects the Submit button 2506, the Current Balance page 2510 is presented, as shown in FIG. 25B (Step 412, FIG. 4). Similarly, the Site suitably presents: the Pending Travel Requests page 2512 which identifies those voucher requests still awaiting approval by the Administrator, as shown in FIG. 25C; the Approved Travel Requests page 2514 which provides a history of all approved vouchers, as shown in FIG. 25D; and the Sponsor Travel Credits page 2516 which allows a Recipient to see which Sponsors have provided specific credits, as shown in FIG. 25E (Steps 414-420, FIG. 4). The Site allows a Recipient to receive credits from more than one Sponsor. Further, all credits awarded to a Recipient may be totaled or kept separately as specific needs and rules for the program dictate.

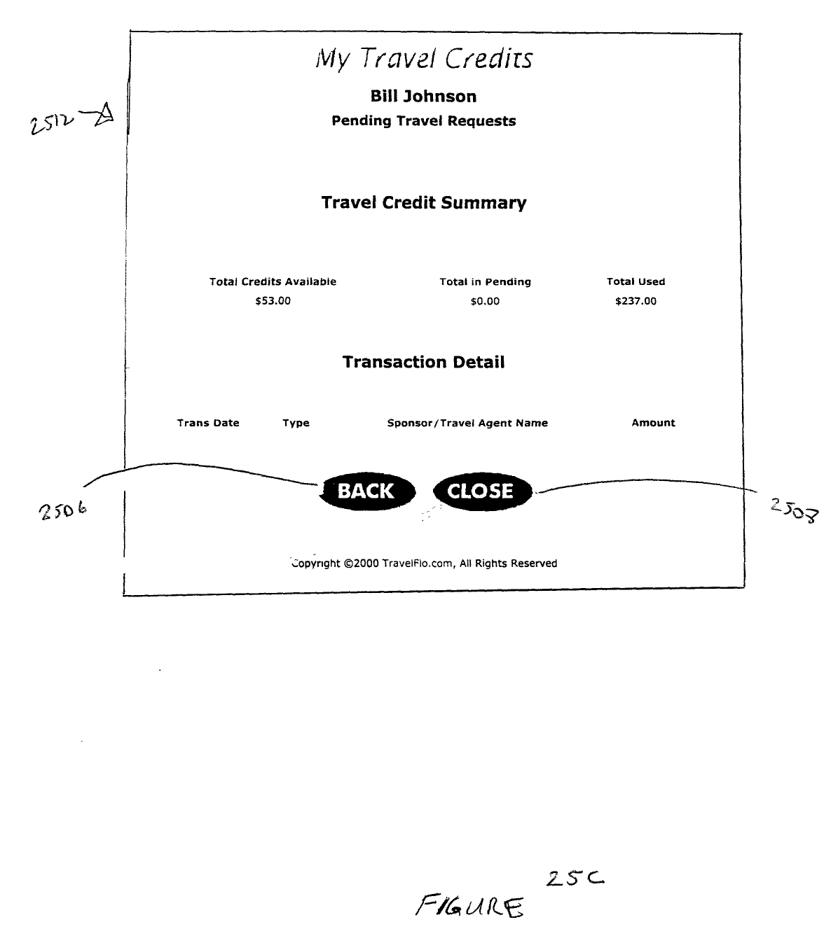

When the user selects the Close button 2508, the Site preferably returns to the Recipient Options page 2300 (FIG. 23). The next option provided is the Request Travel Voucher link 2306. When this option is selected, the Site presents the Request Travel Voucher page 2600, as shown in FIG. 26. This page 2600 includes a field 2602 in which the Recipient identifies the travel agent with whom the Recipient desires to redeem travel credits and a field 2604 in which the Recipient identifies how many credits are to be redeemed (Step 410, FIG. 4). As mentioned previously, the present embodiment provides credits which are utilized in relation to travel, however, the present invention may be modified, as desired, to provide credits for non-travel related expenses by suitably modifying the field 2602.

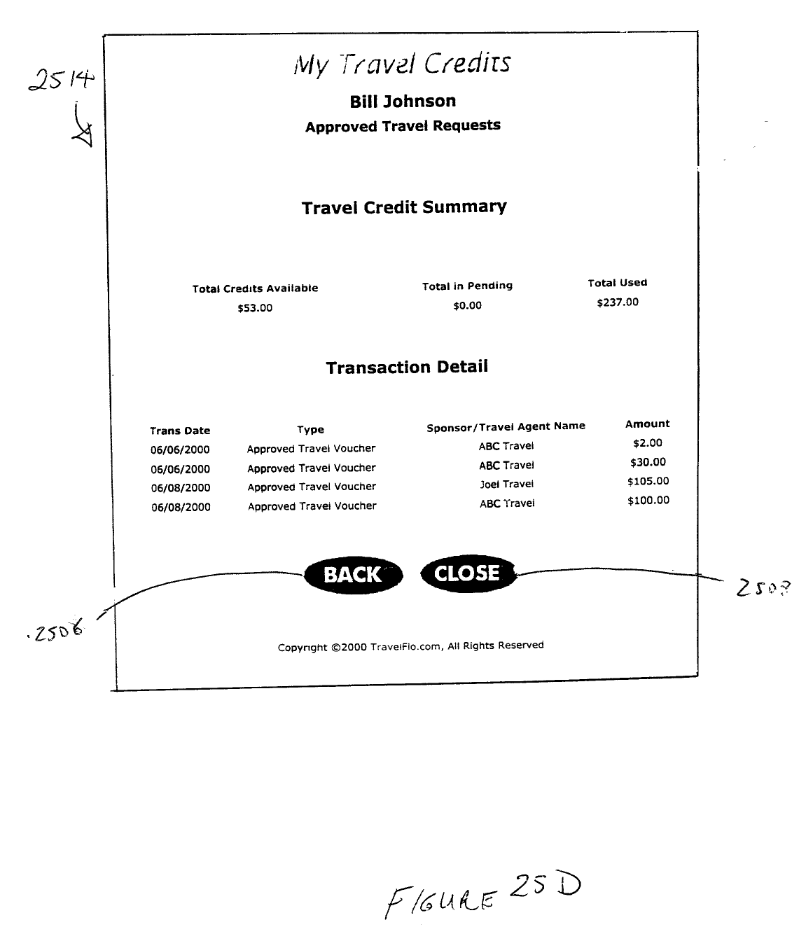

When the Recipient is finished specifying the travel agent and amount of credits to be redeemed, the Recipient selects the Submit button 2606 at which point the Recipient may be prompted to verify the request (Step 412, FIG. 4) and notify the Administrator of the request. Upon reviewing and confirming the request (as desired for specific embodiments), the Site preferably displays the Voucher Status page 2700, as shown in FIG. 27, which notifies the Recipient that their request has been submitted to the ASP preferably in an email, an example of which is shown in FIG. 28.

At this point in the process, activity passes to the Administrator, who then must either accept or deny the request. Basically, the process of accepting or denying a request involves verifying the Recipient has available the number of credits requested (Steps 530-534, FIG. 5). Assuming the number of requested credits are available, the Administrator then approves the voucher request (Step 536), confirms the voucher (Step 538), communicates payment information (for example, credit card numbers or bank wire transfer numbers) to the travel agent (or 3^{rd} party vendor) (Step 540), and then notifies both the Recipient and the Sponsor(s) that payment in the amount of the credits has been provided to the travel agent. Those skilled in the art appreciate that such review and approval process may be accomplished automatically using technology well known in the art. Such technology may utilize various levels of automation and human oversight (for example, human approval of large transactions may be required by certain Administrators) and is not to be construed as being limited to any particular system, process, transactional amounts or any other variable.

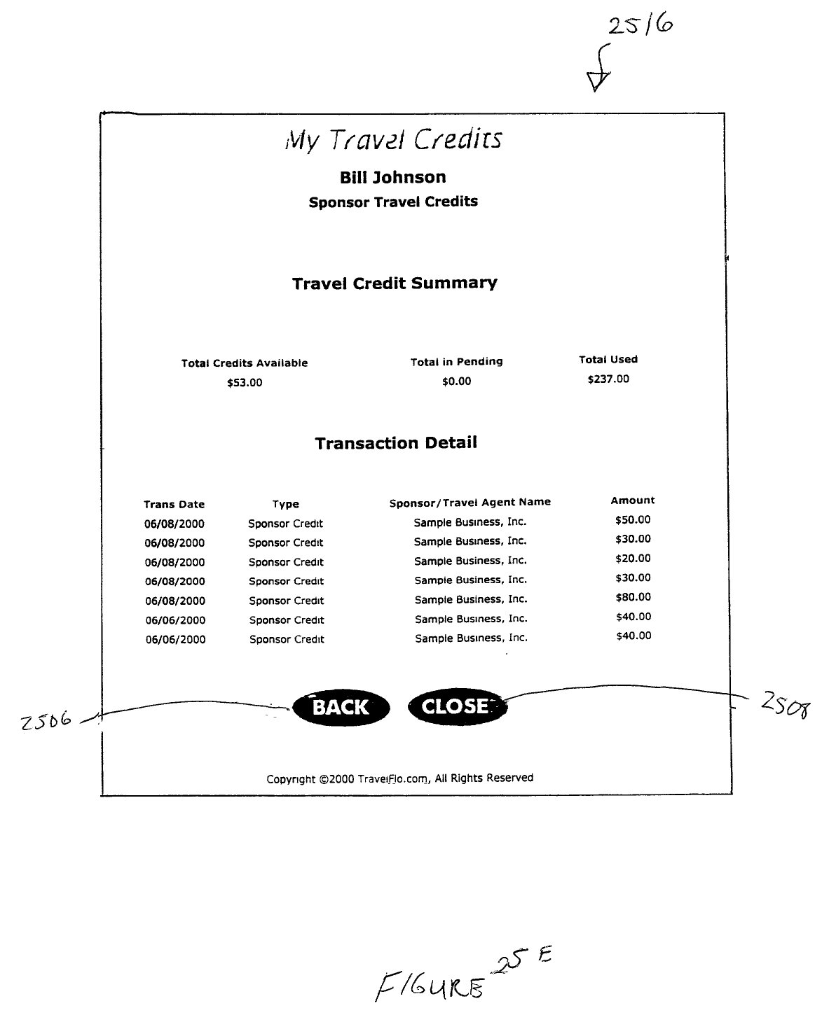

Referring now to FIG. 29, the Administrator Options page 2900 is displayed. As shown, this page 2900 provides an Administrator with various options for maintaining the system 3002, controlling or specifying how downloads occur 3012, managing reporting requirements 3014, and logging off the system 3016. Further, various maintenance tasks are also provided including Sponsor set-up activities 3004, Recipient set-up activities 3006, travel award transaction activities 3006, and voucher request approval activities 3008. Each of these functions is discussed in greater detail below.

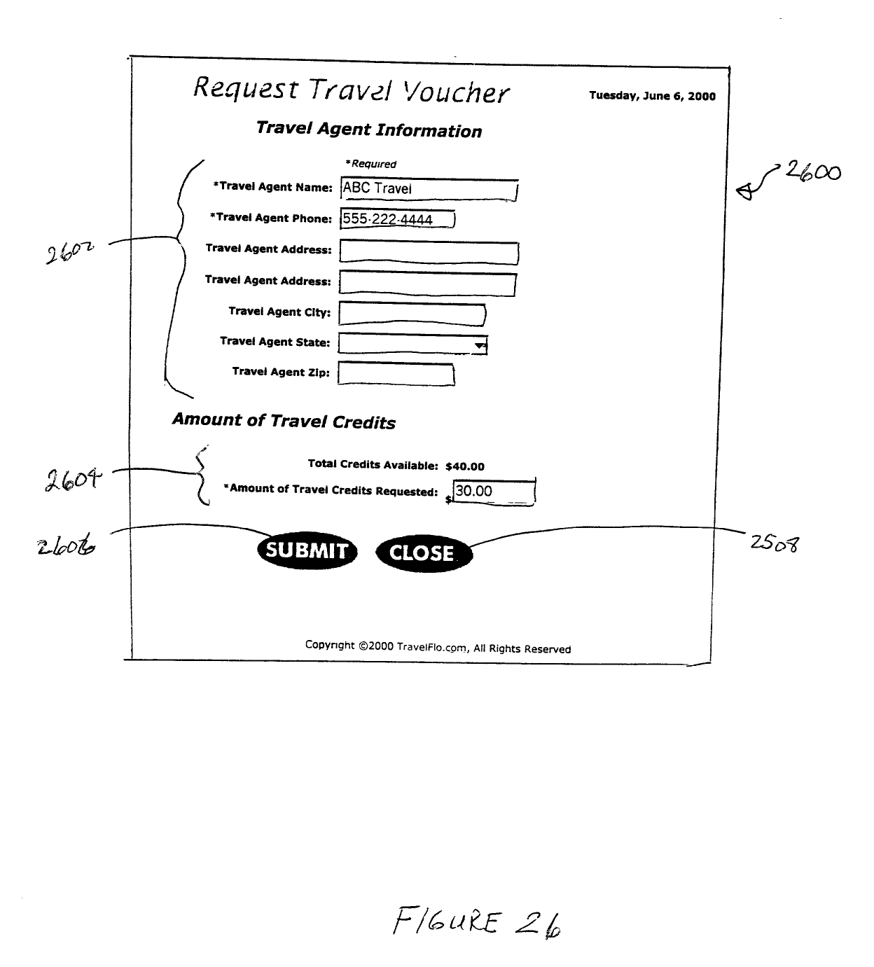

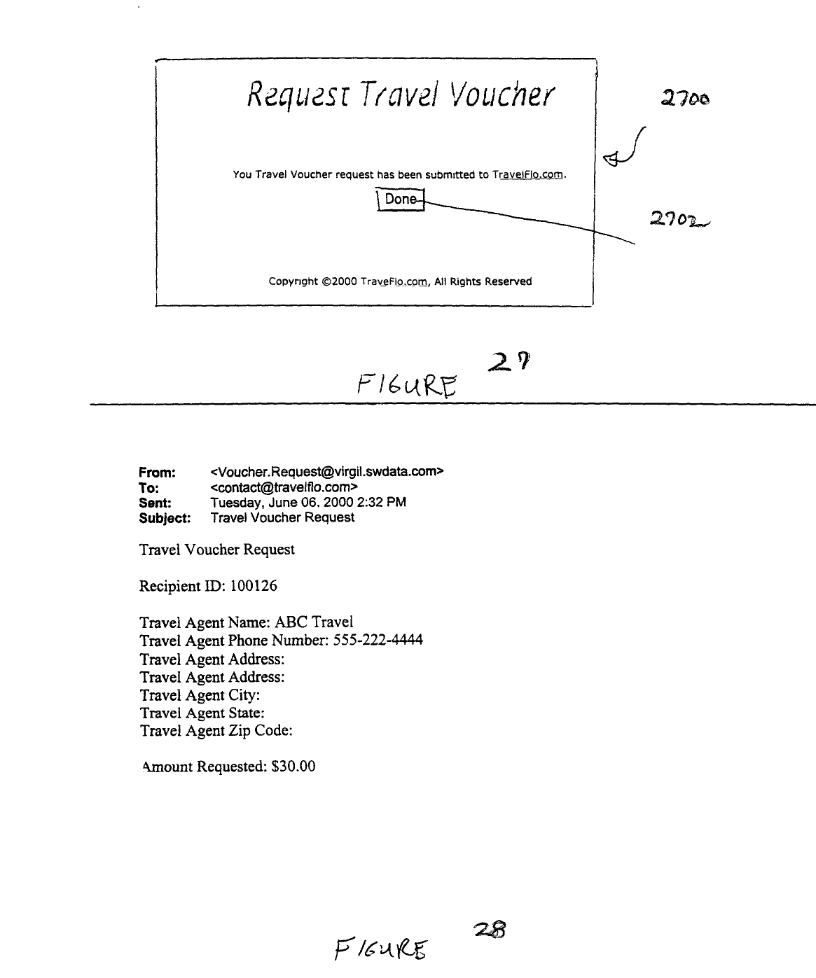

When the Sponsor Set up link 3004 is selected by an Administrator, the Site preferably presents the Sponsor Setup page 3100, as shown in FIG. 30. This page 3100 provides a field 3102 for entering a pin # for an existing Sponsor and a Modify Sponsor button 3104. The Administrator may also elect to add a new Sponsor by selecting the Add New Sponsor button 3106. When information for an existing Sponsor is to be modified, de-activated (for example, when a Sponsor is delinquent in payments), or deleted, the Site displays the Sponsor Maintenance page 3108, as shown in FIG. 31A. This page 3108 provides afield 3110 in which updated information may be provided for the identified Sponsor and selections to activate, de-active, update, or delete the Sponsor in field 3112. The submit button 3114, when selected, directs the Site to make the necessary modifications to the data records for the Sponsor. Additionally, the Reset button 3116 enables the Administrator to restore parameters to their previously saved values prior to saving the new information.

When a new Sponsor is being added, the Site suitably presents the Sponsor Setup page 3118, as shown in FIG. 31B. This page 3118 mirrors the Sponsor Maintenance page 3108 (FIG. 31A) with the exception that the update and delete buttons are not present. FIG. 31C is a representation of a message 3120 generated by the Site when a new Sponsor has been added and a new pin number generated. The Site preferably also sends an email to the Sponsor notifying them of their new pin number.

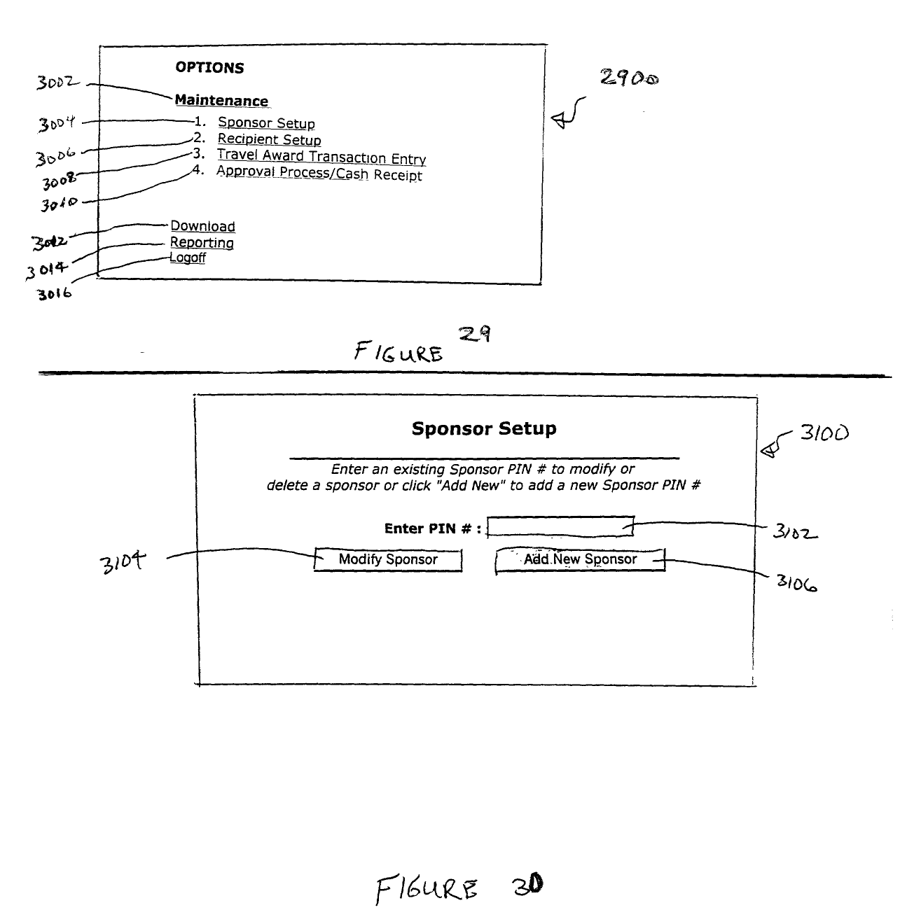

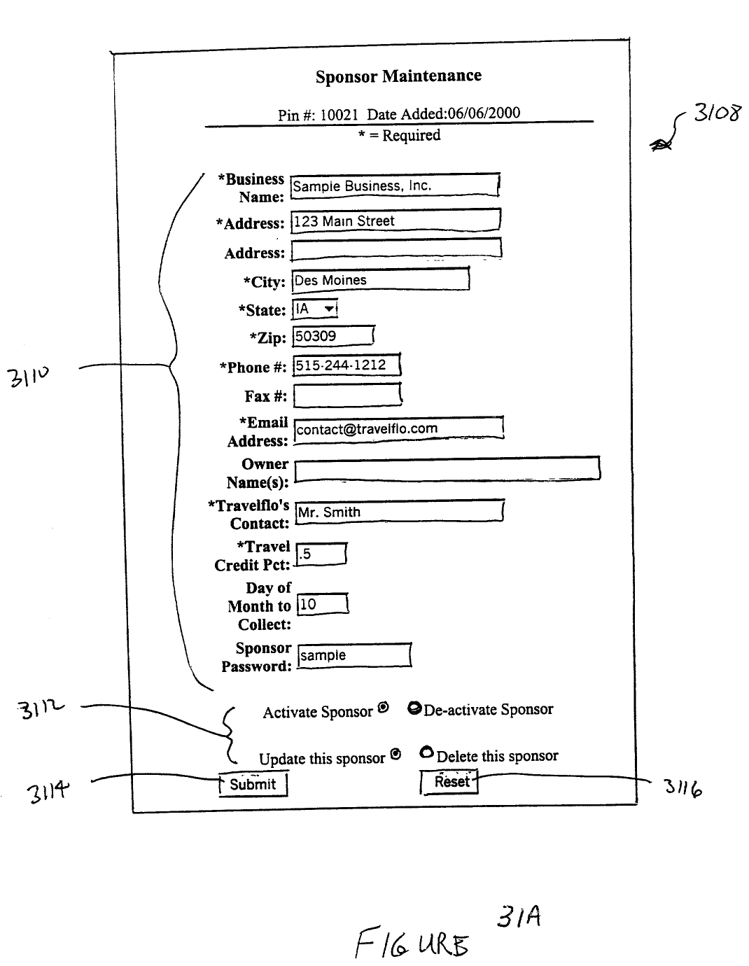

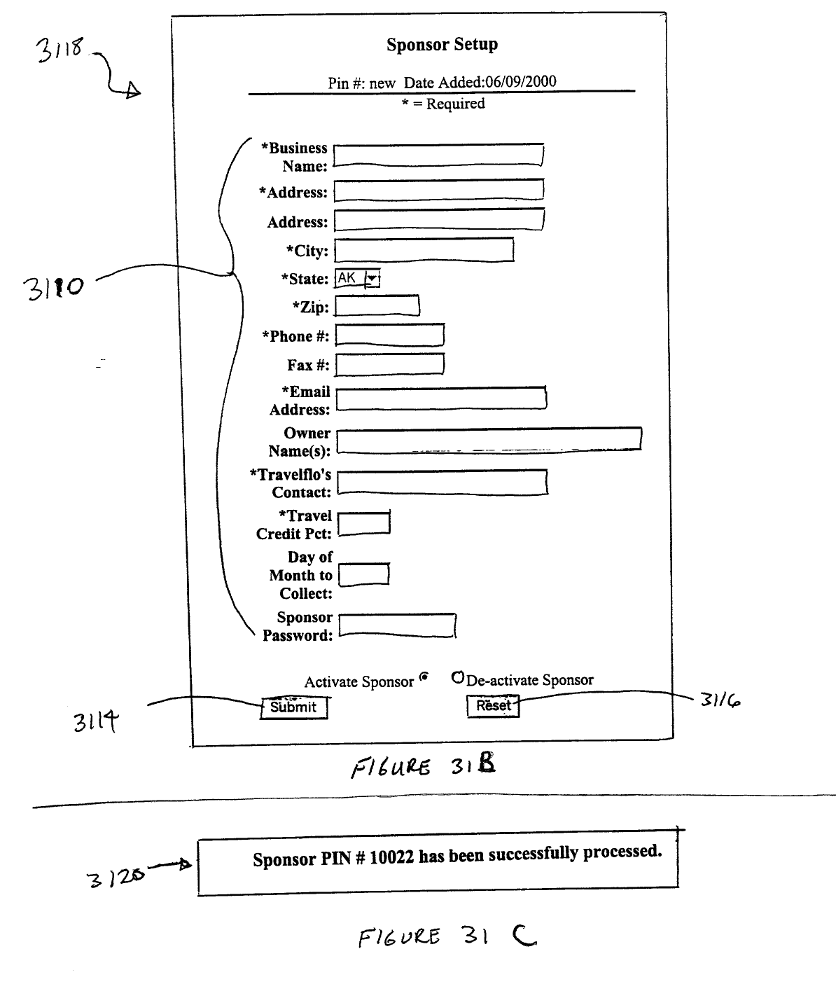

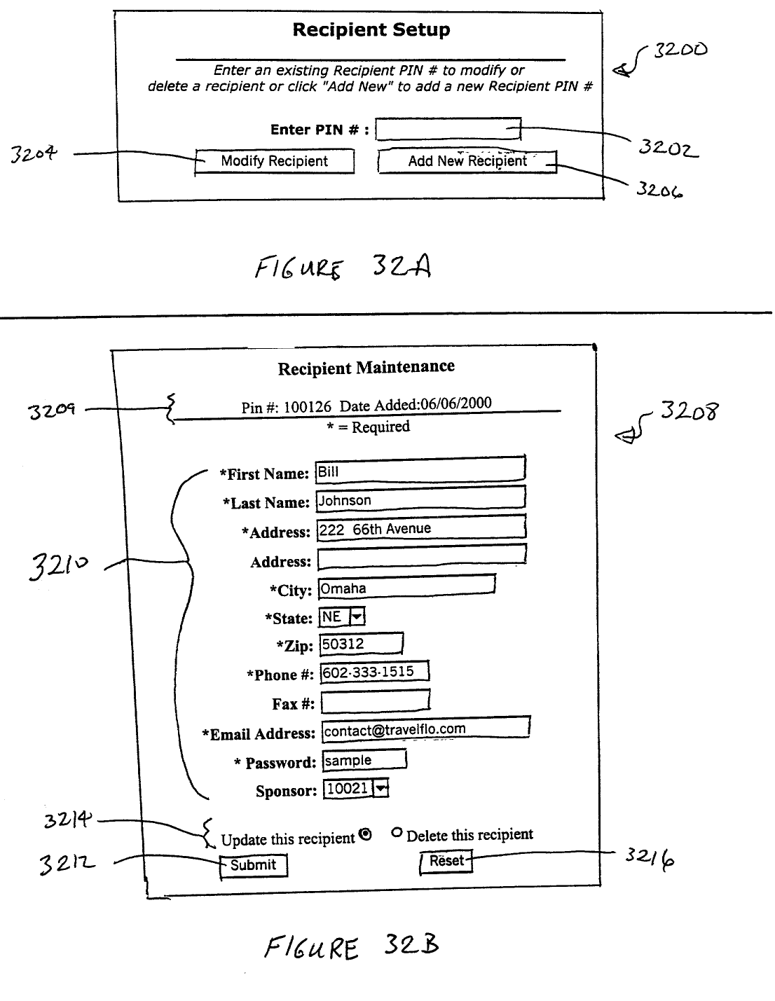

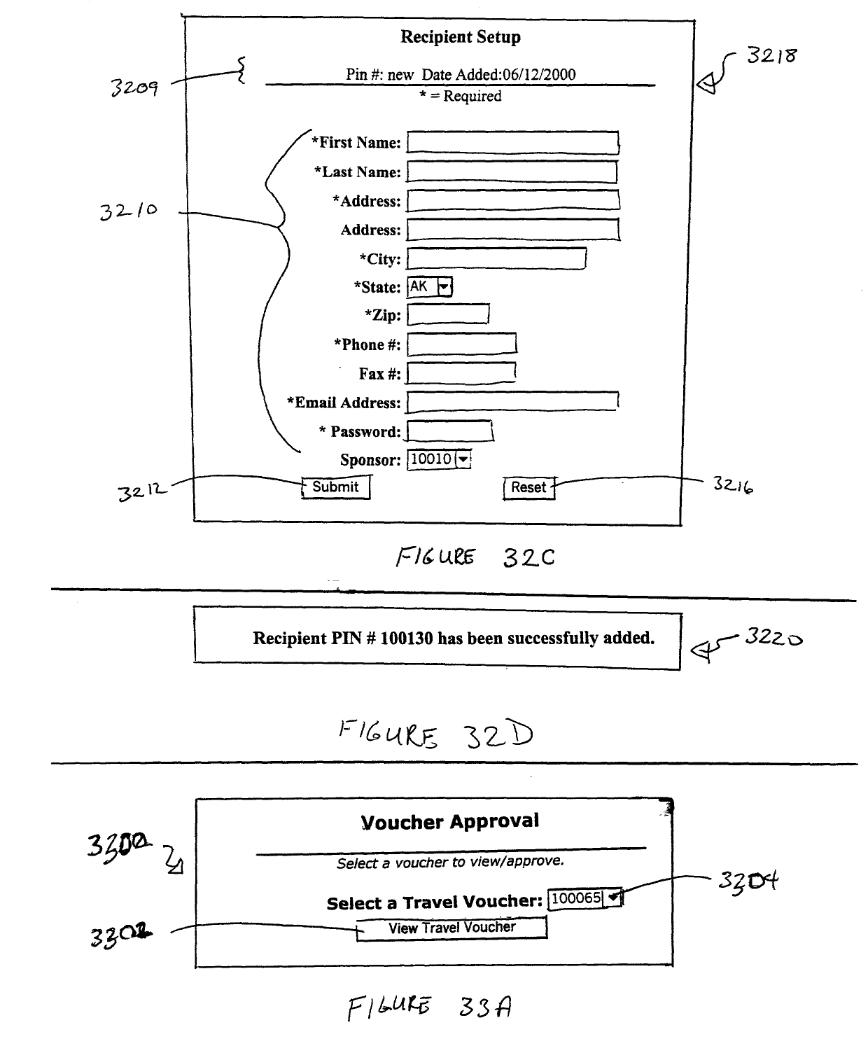

FIGS. 32A to 32D provide illustrations of the pages presented by the Site when the Administrator desires to modify, add, update, or delete Recipient information. As provided for the Sponsor setup pages, the Recipient setup pages also allow the Administrator to modify parameters and receive pin number information for new Recipients. Additionally, since a Recipient may be eligible to receive credits from more than one Sponsor, the Site preferably allows an Administrator to associate a recipient with more than one Sponsor via the pin number.

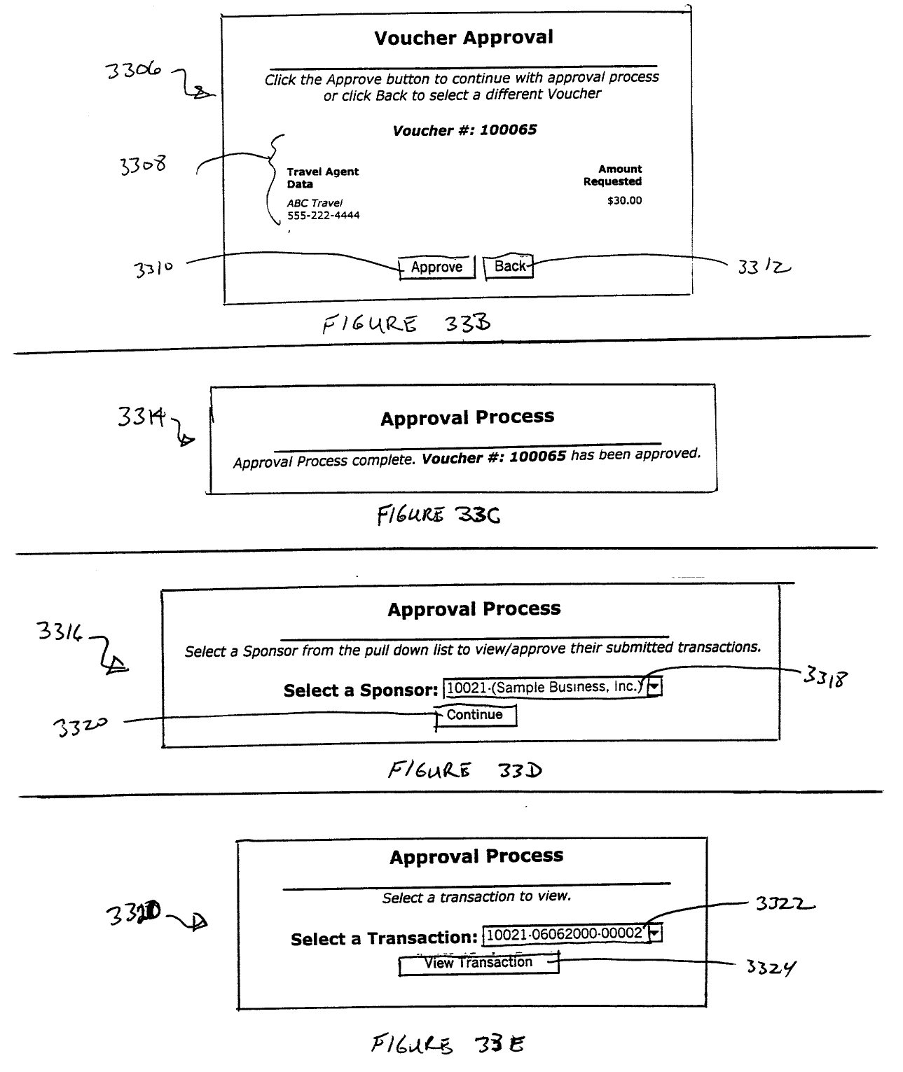

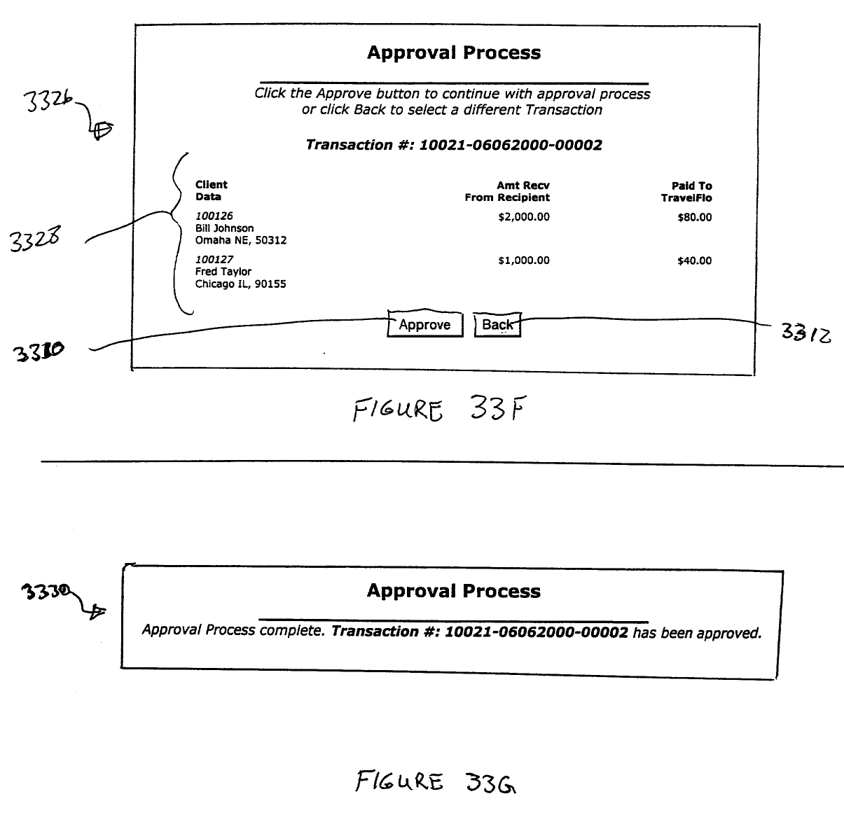

As mentioned previously, the Administrator preferably approves voucher and transaction requests. FIGS. 33A to 33G illustrate the process by which the Administrator reviews, approves and confirms such voucher and transaction requests, as discussed previously herein.

More specifically, when an Administrator needs to review and approve a voucher, the Administrator preferably selects the Approval Process/Cash Receipt link 3010 (FIG. 29) at which instance the Site presents the Voucher Approval page 3300, as shown in FIG. 33A. This page 3300 provides a pull down menu field 3304 and a View Travel Voucher button 3302 by which an Administrator may select to review a travel voucher awaiting approval. FIG. 33B is an illustration of a voucher awaiting approval as shown on the page 3306 presented by the Site. This page 3306 preferably identifies in field 3308 the travel agent and the amount of the request. The Administrator may either approve the request, via the Approve button 3310, or return to the previous page via the Back button 3312. As shown for this embodiment, the Administrator merely verifies the travel agency and the amount and is not required to verify the Recipient has sufficient credits in their account. Such verification is preferably accomplished at the time the Recipient is submitting the voucher request via automated processes well known in the art. Further, this embodiment may be suitably modified such that voucher requests are automatically approved, or are approved based upon a preferred list of travel agents or 3^{rd} party vendors (i.e., requests to preferred vendors are automatically approved, whereas requests to non-preferred vendors may require manual approval-and hence may be delayed). When a voucher is approved, the Site suitably presents to the Administrator an Approval message 3314, as shown in FIG. 33C. Additionally, the Site utilizes a similar process for the transaction approval process, as shown in FIGS. 33D to 33G.

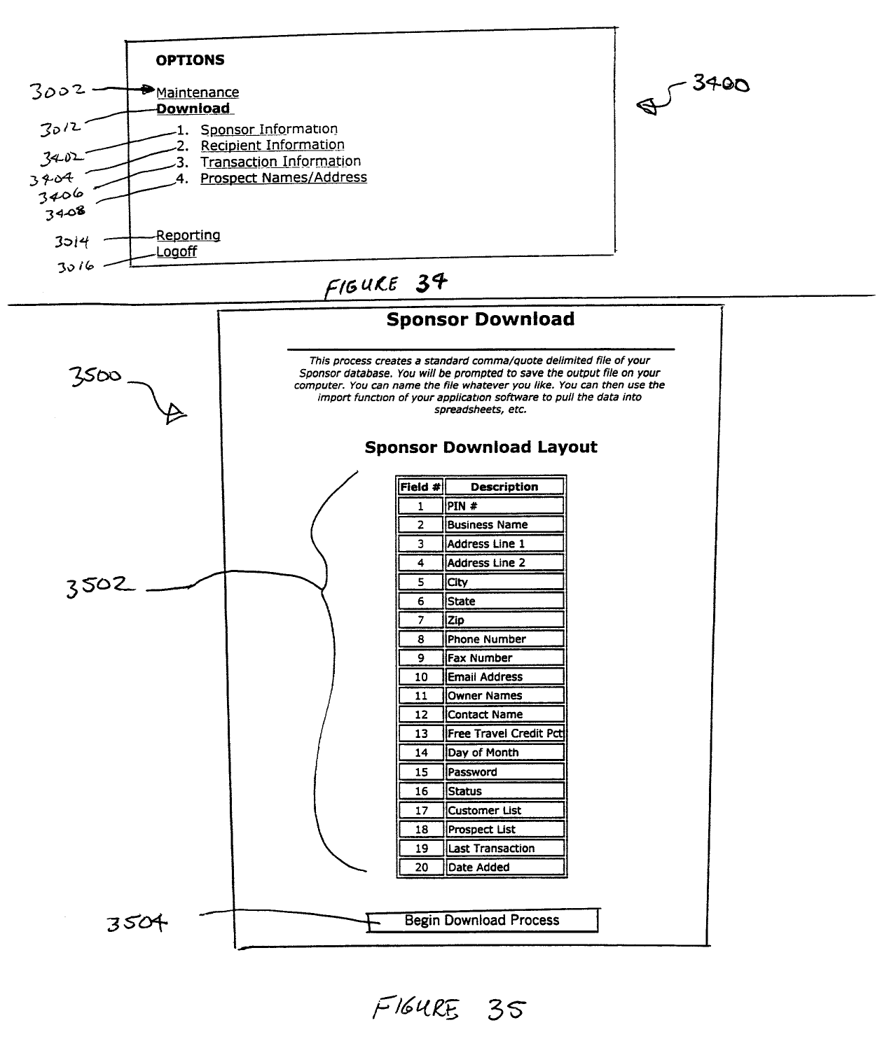

The Site also provides the Administrator with various levels of control over the downloading process. As mentioned previously and with reference now to FIG. 34, the Site provides the Administrator with options to control the downloading of Sponsor Information via link 3402, Recipient Information via link 3402, Transaction Information via link 3404 and Prospect Names/Address information via link 3408. More specifically, when the Sponsor Information link 3402 is selected, the Site presents the Sponsor Download page 3500, as shown in FIG. 35. This page 3500 provides a field 3502 in which the Administrator may specify which parameters are provided to the Sponsor when a download is requested. The Begin Download Process button 3504 suitably allows the Administrator to view the results of a download as they would appear to a Sponsor. Preferably, only one Sponsor Download layout is provided by the Site, however, various download layouts may be designed and utilized as particular needs dictate. Those skilled in the art appreciate that additional screens and templates may be created and used in conjunction with the present invention to facilitate such multiple download layouts. Further, the downloads are preferably accomplished using Microsoft Excel®. Those skilled in the art appreciate that other file formats may be also be used.

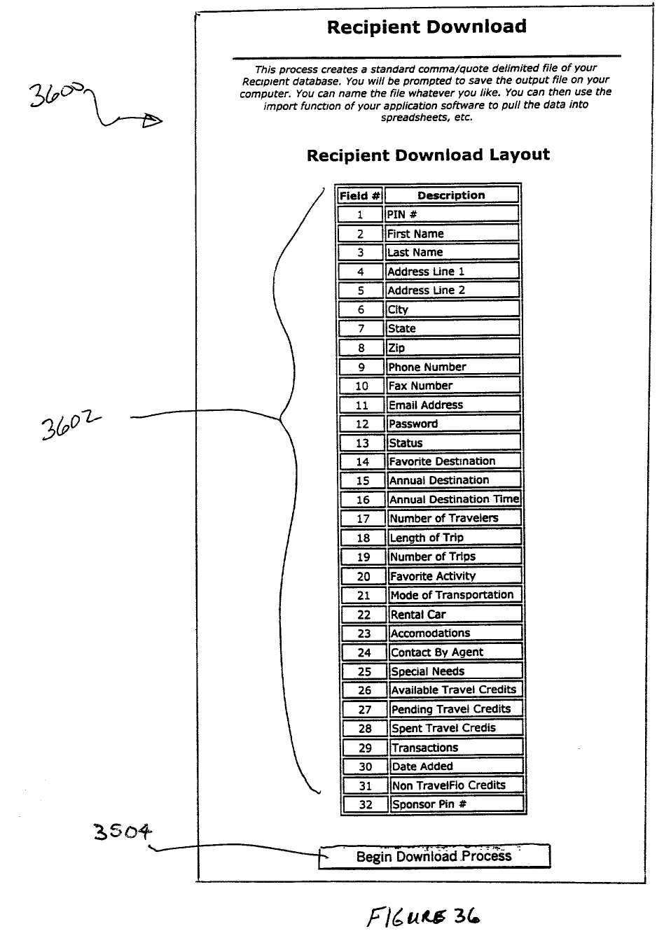

FIGS. 36, 37, and 38 also provide pages 3700, 3800, and 3900, respectively, for specifying the layout of downloaded information for Recipients, Transactions, and Prospects, respectively. The features, functions and capabilities of such pages are similar to those for the Sponsor Download layout page previously discussed.

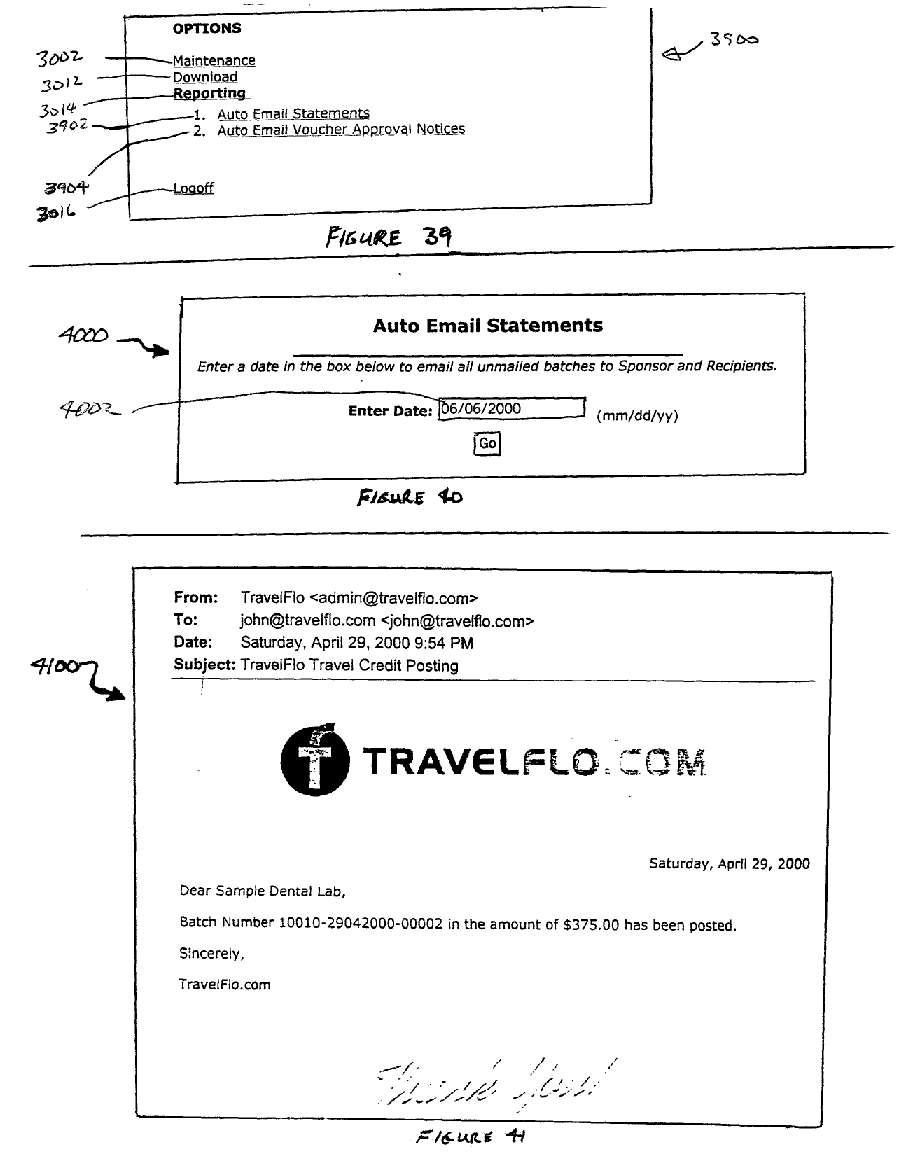

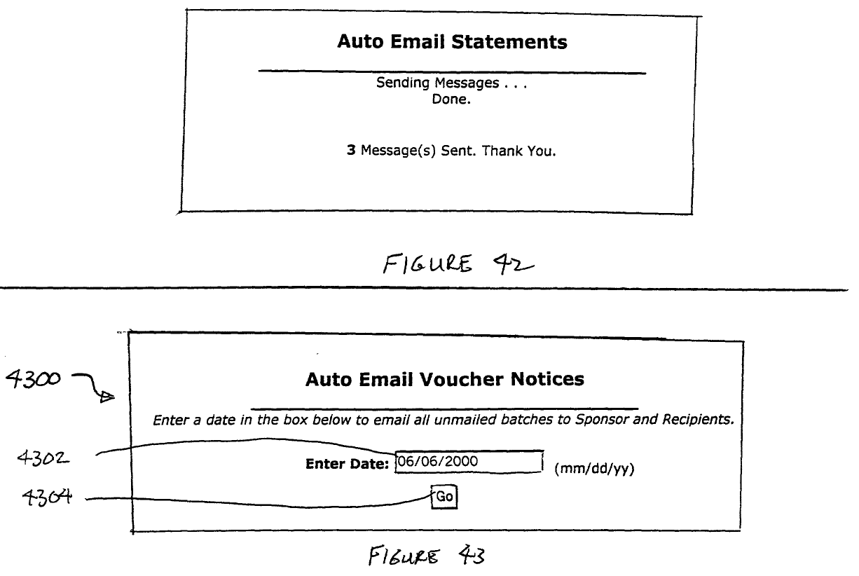

The Site also provides the Administrator with various reporting functions. As shown in FIG. 39, the Site provides and Auto Email Statements link 3902 and an Auto Email Voucher Approval Notices link 3904 on the Options page 3900. When the Auto Email Statements link 3902 is selected, the Site preferably presents the Auto Email Statements page 4000, as shown in FIG. 40. This page provides a date entry field 4002 into which an Administrator inputs a date for the transmission of all unmailed batches to Sponsors and Recipients. The email 4100 shown in FIG. 41 is an example of one such email statement sent to a Sponsor. Further, when the date for auto emailing the batch statements arises, the Site suitably notifies the Administrator that such statements have been sent, as shown by the Notification in FIG. 42.

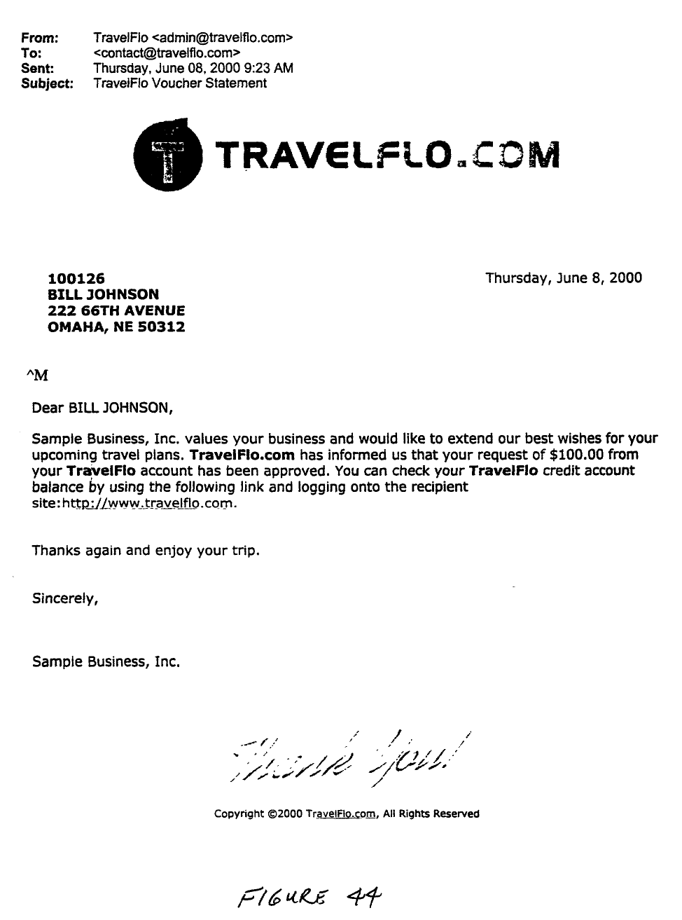

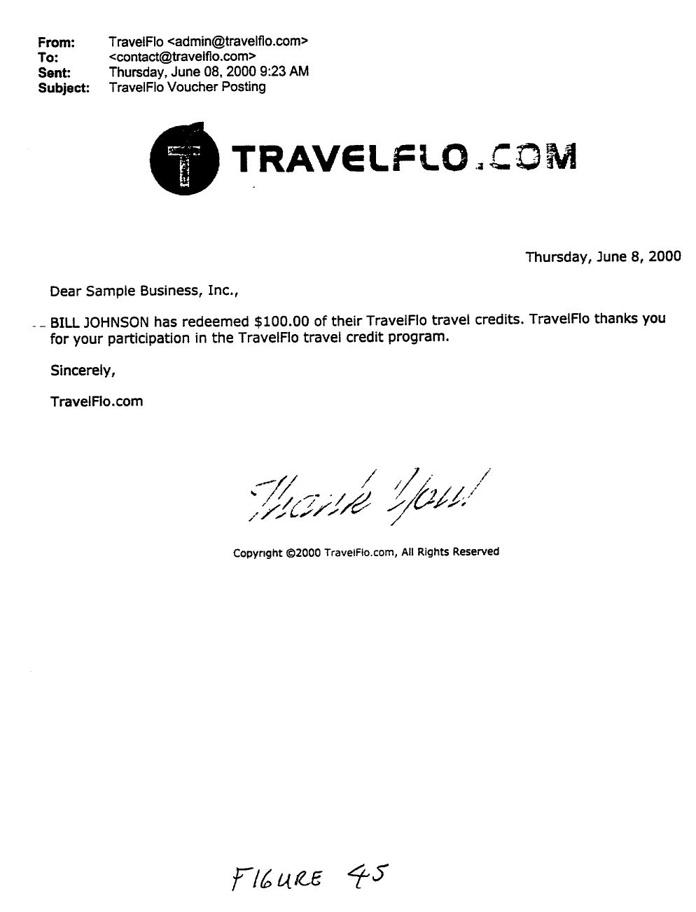

Similarly, unmailed voucher notices can also be designated to be automatically sent by a date specified in the date field 4302 provided in the Auto Email Voucher Notices page 4300, as shown in FIG. 43. Lastly, FIG. 44 provides an example of email statements sent by the present embodiment to a Recipient for a voucher request and FIG. 45 provides an example of a notification email to a Sponsor that a Recipient has redeemed credits towards travel.

As such, the present invention provides a system and process for providing credits to a Recipient who has paid billed charges, identified as accounts receivables on a Sponsor's books,

1. A process for awarding a credit to a Recipient as an incentive for the timely payment of a billed charge, wherein the billed charge is identified on a Sponsor's books as an account receivable, comprising:
receiving an identification of an eligible Recipient;
receiving an identification of at least one qualified account receivable associated with the eligible Recipient;
generating an award based upon the amount of the at least one qualified account receivable; and
rewarding the award to the Recipient.

2. The process of claim 1, wherein the eligible Recipient is a customer who has timely paid charges billed by a Sponsor, wherein the charges when billed are recorded as an accounts receivable on accounting books for the Sponsor.

3. The process of claim 1, wherein the identification of an eligible Recipient is received from a Sponsor that has provided goods or services to a customer and the qualified account receivable further comprises the value of the goods or services provided by the Sponsor to the customer on an accounts receivables basis.

4. The process of claim 1, wherein the Recipient is an entity identified by a customer of a Sponsor, the entity comprising at least one selected from the group consisting of: a person, a business, a charitable organization, and a legal entity.

5. The process of claim 1, wherein the identification of an eligible Recipient is received from a Sponsor who has accessed a database containing at least one customer and a billing record associated with the at least one customer, searched the database for those customers who over a given period have timely paid any billed charges; and designated each customer identified by the search as an eligible Recipient.

6. The process of claim 1, wherein the award further comprises a credit to an account.

7. The process of claim 6, wherein the credit is utilized by the Recipient to reduce the costs of goods/services accrued from a third party vendor.

8. The process of claim 7, wherein the third party vendor further comprises a travel agency and the costs of goods/services are travel related costs.

9. The process of claim 1, wherein the step of rewarding the award to the Recipient further comprises:
saving the award in an account associated with the Recipient;
notifying the Recipient of the award; and
maintaining the award in the account until the Recipient redeems the award.

10. A process for awarding credits used to reduce the cost of travel related services, wherein the credit is awarded by a Sponsor to a customer for timely payment of billed charges, wherein the billed charges appear as accounts receivables on the Sponsor's accounting books, comprising:
receiving a payment from a customer for a billed charge;
determining whether payment is timely;
identifying the customer to a system providing credits to designated recipients when the payment is timely;
identifying the amount of accounts receivables qualified to receive a credit, wherein the accounts receivables are associated with the customer and the billed charges;
generating a credit for the customer, wherein an amount of the credit is determined based upon the qualified accounts receivables;
saving the credit in an account accessible by the recipient; and
providing a selected number of credits to a travel agency when the customer submits a request to redeem the selected number of credits from the account;
whereupon redeeming the selected number of credits, the system transfers payment of an amount equal to the selected number of credits to the travel agency to offset the cost of travel requested by the customer.

11. The process of claim 10, wherein the travel agency and the system are combined into a single system.

12. The process of claim 10, wherein the system is accessed via an Internet connection.

13. The process of claim 10, wherein the customer is notified each time a credit is saved to the account.

14. The process of claim 10, wherein the Sponsor is a service provider selected from the group consisting of: a lawyer, a doctor, a dentist, an architect, a minister, and an educator.

15. The process of claim 10, wherein the Sponsor sells goods.

16. A process for utilizing credits to offset the costs of acquiring goods/services, wherein the credits are awarded by a Sponsor based upon the timely payment of accounts receivables, comprising:
determining a number of credits saved in an account administered by a system providing credits for the timely payment of accounts receivable for a Sponsor subscribing to the system;
determining a goods/services to be purchased from a third party vendor;
identifying to the system the third party vendor;
requesting an amount of credits to be applied to a purchase of the goods/services from the third party vendor; and
completing the purchase of the goods/services from the third party vendor upon receiving notification from the system that the requested credits have been paid to the third party vendor;
wherein the credits are awarded and saved in the account based upon the timely payment of billed charges identified by a Sponsor as an account receivable.

17. The process of claim 16, wherein the credits are awarded to supplement the cost of acquiring travel related goods/services and the third party vendor is a travel agency.

18. The process of claim 16, wherein the Sponsor identifies on a periodic basis to the system a qualified customer and a number of qualified accounts receivables associated with the qualified customer.

19. A process for communicating to a credit administering system an identification of a Recipient and qualified accounts receivables upon which credits are based, comprising:
establishing a communications link with a system for administering credits to a Recipient;
identifying to the system a Recipient eligible to receive a credit; and
identifying qualified accounts receivables associated with the Recipient;
wherein the system upon receiving the identification of the Recipient and the identification of the qualified accounts receivables awards a credit to an account associated with the Recipient, wherein the credits may be utilized by the recipient to offset the cost of acquiring goods/services provided by a third party vendor.

20. The process of claim 19, wherein the Recipient is a customer of a Sponsor identifying the qualified accounts receivables.

21. The process of claim 19, wherein the Recipient is associated with a customer of a Sponsor, the Recipient being selected from the group consisting of: a person, a business, a charitable organization, and a legal entity.

22. The process of claim 19, wherein the credits are redeemed for travel related goods/services.

23. The process of claim 19, wherein the third party vendor further comprises a travel agency.

24. The process of claim 19, wherein the step of identifying qualified accounts receivables is accomplished via a file transfer from a Sponsor system to the system for administering credits.

25. The process of claim 19, wherein the step of identifying qualified accounts receivables is accomplished via an electronic file transfer from a Sponsor system to the system for administering credits.

26. A system for providing credits to a Recipient, wherein the Recipient has timely paid an account receivable for a Sponsor, comprising:
a Sponsor system;
an Administrating system connected to the Sponsor system;
a Recipient system, connected to the Administrating system; and
a third party vendor system;
whereupon receiving an identification of a Recipient and at least one qualified account receivable associated with the Recipient from the Sponsor system, the Administering system determines a credit to award to a Recipient, the Recipient accessing the credit via the Recipient system and identifying the third party vendor to whom the credit is to be paid to offset a cost of acquiring goods/services from the third party vendor.

27. The system of claim 26, wherein the Sponsor system further comprises at least one device selected from the group consisting of: a personal computer, a wireless communications device, and a personal data assistant.

28. The system of claim 27, wherein the device is Internet compatible.

29. The system of claim 26, wherein the Administering system further comprises an application service provider accessible via a network selected from the group consisting of: the Internet, an intranet, a private network, a public network, and a local area network.

30. The system of claim 26, wherein the Sponsor system, the Administering system, and the Recipient system are connected via the Internet.

31. The system of claim 26, wherein the Recipient system further comprises a device selected from the group consisting of: a personal computer, a wireless communications device, and a personal data assistant.

32. The system of claim 26, wherein the credits further comprise a travel voucher for offsetting the costs of travel related goods/services.

33. The system of claim 32, wherein the third party vendor is a travel agency.

34. The system for administering the awarding of credits to a Recipient based upon the timely payment of billed charges identified by a Sponsor as an account receivable, comprising:
an input port for receiving an identification of a Recipient and a qualified account receivable associated with the Recipient from a Sponsor;
a processing system for determining a credit to award to the Recipient based upon the qualified account receivable;
a database for storing the credit until redeemed by the Recipient for the acquiring of a good/service from a third party vendor; and
a communications port for communicating an amount of at least one credit selected by the Recipient for redemption to the third party vendor;
wherein the credit is utilized to offset the cost of goods/services provided by the third party vendor as an incentive to continue to timely pay billed charges appearing on a Sponsors books as an account receivable.

35. The system of claim 34, wherein the system further comprises an application service provider accessible via a network connection.

36. The system of claim 35, wherein the network connection further comprises a network selected from the group consisting of: the Internet, an intranet, a private network, a public network, and a local area network.

37. The system of claim 34, wherein the credit further comprises a travel voucher and the third party vendor further comprises a travel agency which accepts the credit in the form of a check, a wire transfer, and a credit card number.

38. The system of claim 34, wherein the third party vendor communicates with the system via a telecommunications medium selected from the group consisting of: the Internet, a wired communications link, and a wireless communications link.

39. The system of claim 34, wherein the database is co-located with the processing system.

40. The system of claim 34, wherein the database is remote to the processing system.

41. The system of claim 34, wherein the Recipient is a customer of the Sponsor.

42. The system of claim 34, wherein the system notifies at least one prospect of the goods/services provided by the Sponsor and the opportunity to enroll in the credit administering system.

43. A method for creating incentives for paying billed charges on a timely basis, comprising:
identifying a customer who pays billed charges on a timely basis, wherein the billed charges are identified on a Sponsor's books as an account receivable;
determining an amount of the account receivable which qualify for the awarding of a credit; and
awarding a credit to the customer based upon the outcome of the determination;
wherein the credit creates a monetary incentive for the customer to timely pay billed charges.

44. The method of claim 43, wherein the monetary incentive further comprises a travel credit redeemable with a travel agency selected by the customer.

45. The method of claim 43, wherein the credit is accumulated with other credits into a lump sum of credits.

46. The method of claim 43, wherein the credit is redeemed by the customer to offset the cost of travel related goods/services.

47. A system for awarding credits to a Recipient for the timely payment of billed charges from a Sponsor, comprising:
a means for identifying a Recipient, wherein the Recipient timely paid at least one billed charge from a Sponsor;
a means for identifying an amount of the at least one billed charge;
a means for generating a credit based upon the amount of the at least one billed charge;
a means for notifying the Recipient of the credit; and
a means for saving the credit until the Recipient identifies a third party vendor with whom the credit is to be redeemed;
whereupon redemption of the credit the third party vendor receives a payment equal to the value of the credit from the means for generating a credit.

48. The system of claim 47, wherein the at least one billed charge is identified by a Sponsor as an account receivable.

49. The system of claim 47, wherein the means for generating a credit further generates a credit based upon a purchase by the Recipient of a specific goods/services.

50. The system of claim 47, wherein the means for notifying the Recipient of the credit further comprises an email message.

51. The system of claim 47, wherein the means for saving the credit further comprises a database accessible by the means for generating a credit.

52. The system of claim 47, wherein the credit further comprises a travel voucher.

53. The system of claim 47, wherein the third party vendor further comprises a travel agency.

54. The system of claim 47, wherein the credit is redeemed with the third party vendor by providing a credit card number.

55. The system of claim 47, wherein the means for notifying the Recipient of the credit further comprises an advertisement for the goods/services offered by the Sponsor.

56. The system of claim 47, wherein the Sponsor is one selected from the group consisting of: a doctor, a lawyer, a dentist, an architect, and a service professional.

57. A computer readable medium containing instructions for generating a credit to a Recipient based upon qualified accounts receivables associated with the Recipient received from a Sponsor, by:
receiving an identification of an eligible Recipient;
receiving an identification of at least one qualified account receivable associated with the eligible Recipient;
generating an award based upon the amount of the at least one qualified account receivable; and
rewarding the award to the Recipient.

58. The computer readable medium of claim 57, wherein the identification of an eligible Recipient is received over a communications links selected from the group consisting of: the Internet, an intranet, a wired telecommunications link, a wireless telecommunications link, a private network, and a public network.

59. The computer readable medium of claim 57, wherein the credit further comprises a travel voucher utilized to offset travel related costs incurred by the Recipient from a travel agency.

60. The computer readable medium of claim 57, wherein the instructions further comprise paying an amount of credits redeemed by a Recipient to a third party vendor.

61. The computer readable medium of claim 60, wherein the credits are payed to the third party vendor via a credit card.

62. The computer readable medium of claim 60, wherein the credits are paid in cash to the third party vendor.
